(19) United States
(12) Patent Application Publication
(10) Pub. No.: US 2015/0135284 A1
(43) Pub. Date: May 14, 2015

(54) AUTOMATIC ELECTRONIC DEVICE ADOPTION WITH A WEARABLE DEVICE OR A DATA-CAPABLE WATCH BAND

(71) Applicant: Travis Austin Bogard, San Francisco, CA (US)

(72) Inventor: Travis Austin Bogard, San Francisco, CA (US)

(73) Assignee: AliphCom, San Francisco, CA (US)

(21) Appl. No.: 14/079,632

(22) Filed: Nov. 13, 2013

(51) Int. Cl. G06F 21/31

(52) U.S. Cl. CPC G06F 21/31
USPC 726/5

(57) ABSTRACT

Embodiments relate generally to electrical and electronic hardware, computer software, human-computing interfaces, wired and wireless network communications, data processing, computing devices, watches, watch bands, and wrist-worn watch-enabled devices. More specifically, techniques for adopting electronic devices using data from a wearable device, such as a data-capable watch band are described. In some examples, a wearable device can include an adoption controller configured to detect the short-range communication link. Further, the wearable device can be configured to transmit key data to an electronic device to transition the electronic device from a lender mode of operation to a lendee mode of operation to enable the wearer to use the electronic device.

### CROSS-REFERENCE TO RELATED APPLICATIONS

This U.S. non-provisional patent application is a continuation-in-part U.S. non-provisional patent application of U.S. patent application Ser. No. 13/______, filed MMMM DD, YYYY, entitled “Data-Capable Band for Medical Diagnosis, Monitoring, and Treatment,” which is a continuation-in-part U.S. non-provisional patent application of U.S. patent application Ser. No. 13/180,000, filed Jul. 11, 2011, entitled “Data-Capable Band for Medical Diagnosis, Monitoring, and Treatment,” U.S. patent application Ser. No. 13/180,320, filed Jul. 11, 2011, entitled “Power Management in a Data-Capable Strapband,” U.S. patent application Ser. No. 13/158,372, filed Jun. 10, 2011, and entitled “Component Protective Overmolding,” U.S. patent application Ser. No. 13/158,416, filed Jun. 11, 2011, and entitled “Component Protective Overmolding,” and claims the benefit of U.S. Provisional Patent Application No. 61/495,995, filed Jun. 11, 2011, and entitled “Data-Capable Strapband,” U.S. Provisional Patent Application No. 61,495,994, filed Jun. 11, 2011, and entitled “Data-Capable Strapband,” U.S. Provisional Patent Application No. 61/495,997, filed Jun. 11, 2011, and entitled “Data-Capable Strapband,” and U.S. Provisional Patent Application No. 61/495,996, filed Jun. 11, 2011, and entitled “Data-Capable Strapband,” all of which are herein incorporated by reference for all purposes.

### FIELD

Embodiments relate generally to electrical and electronic hardware, computer software, human-computing interfaces, wired and wireless network communications, data processing, computing devices, watches, watch bands, and wrist-worn watch-enabled devices. More specifically, techniques for adopting electronic devices using data from a wearable device, such as a data-capable watch band are described.

### BACKGROUND

With the advent of greater computing capabilities in smaller personal and/or portable form factors and an increasing number of applications (i.e., computer and Internet software or programs) for different uses, consumers (i.e., users) have access to large amounts of personal data. Information and data are often readily available, but poorly captured using conventional data capture devices. Conventional devices typically lack capabilities that can capture, analyze, communicate, or use data in a contextually-meaningful, comprehensive, and efficient manner. Further, conventional solutions are often limited to specific individual purposes or uses, demanding that users invest in multiple devices in order to perform different activities (e.g., a sports watch for tracking time and distance, a GPS receiver for monitoring a hike or run, a cyclometer for gathering cycling data, and others). Although a wide range of data and information is available, conventional devices and applications fail to provide effective solutions that comprehensively capture data for a given user across numerous disparate activities. Further, tools, functions, or features that allow efficient and activity or state-related management of data-capture devices and content are unavailable in conventional solutions.

Some conventional solutions combine a small number of discrete functions. Functionality for data capture, processing, storage, or communication in conventional devices such as a watch or timer with a heart rate monitor or global positioning system (“GPS”) receiver are available conventionally, but are expensive to manufacture and purchase. Other conventional solutions for combining personal data capture facilities often present numerous design and manufacturing problems such as size restrictions, specialized materials requirements, lowered tolerances for defects such as pits or holes in coverings for water-resistant or waterproof devices, unreliability, higher failure rates, increased manufacturing time, and expense. Subsequently, conventional devices such as fitness watches, heart rate monitors, GPS-enabled fitness monitors, health monitors (e.g., diabetic blood sugar testing units), digital voice recorders, pedometers, altimeters, and other conventional personal data capture devices are generally manufactured for conditions that occur in a single or small groupings of activities. Further, conventional devices typically do not provide features or functions, based on the types of data captured, to manage other information or data, including media devices, applications, formats, and content of various types.

Further, conventional techniques for providing temporary security and/or access to electronic devices are not well-suited for easy and/or automatic transfer of control in the use of electronic devices that would be most effective for a user.

Thus, what is needed is a solution without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary data-capable strapband system;

FIG. 2 illustrates a block diagram of an exemplary data-capable strapband;

FIG. 3 illustrates sensors for use with an exemplary data-capable strapband;

FIG. 4 illustrates an application architecture for an exemplary data-capable strapband;

FIG. 5A illustrates representative data types for use with an exemplary data-capable strapband;

FIG. 5B illustrates representative data types for use with an exemplary data-capable strapband in fitness-related activities;

FIG. 5C illustrates representative data types for use with an exemplary data-capable strapband in sleep management activities;

FIG. 5D illustrates representative data types for use with an exemplary data-capable strapband in medical-related activities;

FIG. 5E illustrates representative data types for use with an exemplary data-capable strapband in social media/networking-related activities;

FIG. 6A illustrates an exemplary system for wearable device data security;

FIG. 6B illustrates an exemplary system for media device, application, and content management using sensory input;

FIG. 6C illustrates an exemplary system for device control using sensory input;

FIG. 6D illustrates an exemplary system for movement languages in wearable devices;

FIG. 7A illustrates a perspective view of an exemplary data-capable strapband;

FIG. 7B illustrates a side view of an exemplary data-capable strapband;

FIG. 8A illustrates a perspective view of an exemplary data-capable strapband;

FIG. 8B illustrates a side view of an exemplary data-capable strapband;

FIG. 9A illustrates a perspective view of an exemplary data-capable strapband;

FIG. 9B illustrates a side view of an exemplary data-capable strapband;

FIG. 10 illustrates an exemplary computer system suitable for use with a data-capable strapband;

FIG. 11A illustrates an exemplary process for media device content management using sensory input;

FIG. 11B illustrates an exemplary process for device control using sensory input;

FIG. 11C illustrates an exemplary process for wearable device data security; FIGS. 13A and 13B depict automatic device adoption based on proximity, according to some embodiments

FIG. 11D illustrates an exemplary process for movement languages in wearable devices;

FIG. 12 is a diagram depicting an adoptable electronic device configured to facilitate adoptive access to one or more portions of the electronic device, according to some embodiments;

FIGS. 13A and 13B depict automatic device adoption based on proximity, according to some embodiments;

FIG. 14 depicts an adoption controller and a device controller, according to some examples;

FIG. 15 depicts an example flow to provide automatic access or automatic device adoption, according to some embodiments;

FIG. 16 depicts an adoption controller configured to block transmission of key data, according to some examples;

FIG. 17 depicts operation data including contact information, according to some embodiments

FIGS. 18A and 18B depict alternate forms of operation data, according to some examples; and

FIG. 19 illustrates an exemplary computing platform disposed in a media device, a mobile device, a wearable device, or any computing device, according to various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

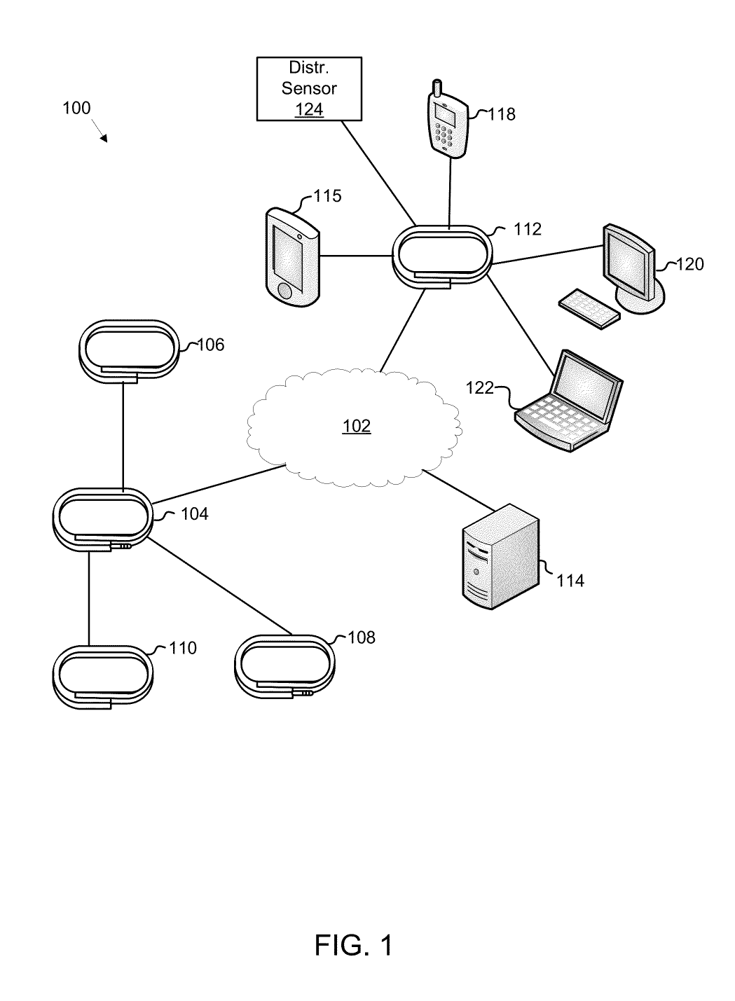

FIG. 1 illustrates an exemplary data-capable strapband system. Here, system 100 includes network 102, strapbands (hereafter “bands”) 104-112, server 114, mobile computing device 115, mobile communications device 118, computer 120, laptop 122, and distributed sensor 124. Although used interchangeably, “strapband” and “band” may be used to refer to the same or substantially similar data-capable device that may be worn as a strap or band around an arm, leg, ankle, or other bodily appendage or feature. In other examples, bands 104-112 may be attached directly or indirectly to other items, organic or inorganic, animate, or static. In still other examples, bands 104-112 may be used differently.

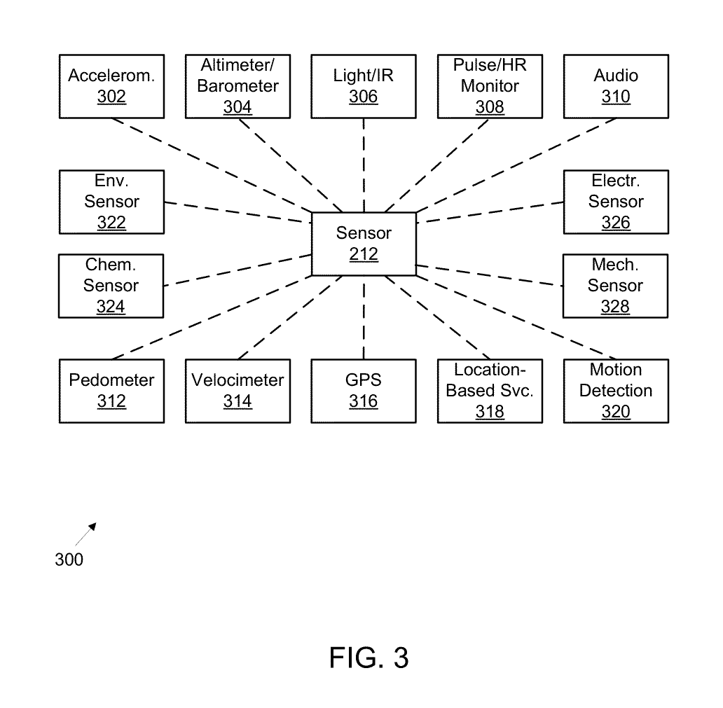

As described above, bands 104-112 may be implemented as wearable personal data or data capture devices (e.g., data-capable devices; as used herein, “data-capable” may refer to any capability using data from or transferred using indirect or direct data communication links) that are worn by a user around a wrist, ankle, arm, ear, or other appendage, or attached to the body or affixed to clothing. One or more facilities, sensing elements, or sensors, both active and passive, may be implemented as part of bands 104-112 in order to capture various types of data from different sources. Temperature, environmental, temporal, motion, electronic, electrical, chemical, or other types of sensors (including those described below in connection with FIG. 3) may be used in order to gather varying amounts of data, which may be configurable by a user, locally (e.g., using user interface facilities such as buttons, switches, motion-activated/detected command structures (e.g., accelerometer-gathered data from user-initiated motion of bands 104-112), and others) or remotely (e.g., entering rules or parameters in a website or graphical user interface (“GUI”) that may be used to modify control systems or signals in firmware, circuitry, hardware, and software implemented (i.e., installed) on bands 104-112). Bands 104-112 may also be implemented as data-capable devices that are configured for data communication using various types of communications infrastructure and media, as described in greater detail below. Bands 104-112 may also be wearable, personal, non-intrusive, lightweight devices that are configured to gather large amounts of personally relevant data that can be used to improve user health, fitness levels, medical conditions, athletic performance, sleeping physiology, and physiological conditions, or used as a sensory-based user interface (“UI”) to signal social-related notifications specifying the state of the user through vibration, heat, lights or other sensory based notifications. For example, a social-related notification signal indicating a user is on-line can be transmitted to a recipient, who in turn, receives the notification as, for instance, a vibration.

Using data gathered by bands 104-112, applications may be used to perform various analyses and evaluations that can generate information as to a person's physical (e.g., healthy, sick, weakened, or other states, or activity level), emotional, or mental state (e.g., an elevated body temperature or heart rate may indicate stress, a lowered heart rate and skin temperature, or reduced movement (excessive sleeping), may indicate physiological depression caused by exertion or other factors, chemical data gathered from evaluating outgassing from the skin's surface may be analyzed to determine whether a person's diet is balanced or if various nutrients are lacking, salinity detectors may be evaluated to determine if high, lower, or proper blood sugar levels are present for diabetes management, and others). Generally, bands 104-112 may be configured to gather from sensors locally and remotely.

As an example, band 104 may capture (i.e., record, store, communicate (i.e., send or receive), process, or the like) data from various sources (i.e., sensors that are organic (i.e., installed, integrated, or otherwise implemented with band 104) or distributed (e.g., microphones on mobile computing device 115, mobile communications device 118, computer 120, laptop 122, distributed sensor 124, global positioning system (“GPS”) satellites, or others, without limitation)) and exchange data with one or more of bands 106-112, server 114, mobile computing device 115, mobile communications device 118, computer 120, laptop 122, and distributed sensor 124. As shown here, a local sensor may be one that is incorporated, integrated, or otherwise implemented with bands 104-112. A remote or distributed sensor (e.g., mobile computing device 115, mobile communications device 118, computer 120, laptop 122, or, generally, distributed sensor 124) may be sensors that can be accessed, controlled, or otherwise used by bands 104-112. For example, band 112 may be configured to control devices that are also controlled by a given user (e.g., mobile computing device 115, mobile communications device 118, computer 120, laptop 122, and distributed sensor 124). For example, a microphone in mobile communications device 118 may be used to detect, for example, ambient audio data that is used to help identify a person's location, or an ear clip (e.g., a headset as described below) affixed to an ear may be used to record pulse or blood oxygen saturation levels. Additionally, a sensor implemented with a screen on mobile computing device 115 may be used to read a user's temperature or obtain a biometric signature while a user is interacting with data. A further example may include using data that is observed on computer 120 or laptop 122 that provides information as to a user's online behavior and the type of content that she is viewing, which may be used by bands 104-112. Regardless of the type or location of sensor used, data may be transferred to bands 104-112 by using, for example, an analog audio jack, digital adapter (e.g., USB, mini-USB), or other, without limitation, plug, or other type of connector that may be used to physically couple bands 104-112 to another device or system for transferring data and, in some examples, to provide power to recharge a battery (not shown). Alternatively, a wireless data communication interface or facility (e.g., a wireless radio that is configured to communicate data from bands 104-112 using one or more data communication protocols (e.g., IEEE 802.11a/b/g/n (WiFi), WiMax, ANT™, ZigBee®, Bluetooth®, Near Field Communications (“NFC”), and others)) may be used to receive or transfer data. Further, bands 104-112 may be configured to analyze, evaluate, modify, or otherwise use data gathered, either directly or indirectly.

In some examples, bands 104-112 may be configured to share data with each other or with an intermediary facility, such as a database, website, web service, or the like, which may be implemented by server 114. In some embodiments, server 114 can be operated by a third party providing, for example, social media-related services. An example of such a third party is Facebook®. Bands 104-112 may exchange data with each other directly or via a third party server providing social-media related services. Such data can include personal physiological data and data derived from sensory-based user interfaces (“UI”). Server 114, in some examples, may be implemented using one or more processor-based computing devices or networks, including computing clouds, storage area networks (“SAN”), or the like. As shown, bands 104-112 may be used as a personal data or area network (e.g., “PDN” or “PAN”) in which data relevant to a given user or band (e.g., one or more of bands 104-112) may be shared. As shown here, bands 104 and 112 may be configured to exchange data with each other over network 102 or indirectly using server 114. Users of bands 104 and 112 may direct a web browser hosted on a computer (e.g., computer 120, laptop 122, or the like) in order to access, view, modify, or perform other operations with data captured by bands 104 and 112. For example, two runners using bands 104 and 112 may be geographically remote (e.g., users are not geographically in close proximity locally such that bands being used by each user are in direct data communication), but wish to share data regarding their race times (pre, post, or in-race), personal records (i.e., “PR”), target split times, results, performance characteristics (e.g., target heart rate, target VO2 max, and others), and other information. If both runners (i.e., bands 104 and 112) are engaged in a race on the same day, data can be gathered for comparative analysis and other uses. Further, data can be shared in substantially real-time (taking into account any latencies incurred by data transfer rates, network topologies, or other data network factors) as well as uploaded after a given activity or event has been performed. In other words, data can be captured by the user as it is worn and configured to transfer data using, for example, a wireless network connection (e.g., a wireless network interface card, wireless local area network (“LAN”) card, cell phone, or the like. Data may also be shared in a temporally asynchronous manner in which a wired data connection (e.g., an analog audio plug (and associated software or firmware) configured to transfer digitally encoded data to encoded audio data that may be transferred between bands 104-112 and a plug configured to receive, encode/decode, and process data exchanged) may be used to transfer data from one or more bands 104-112 to various destinations (e.g., another of bands 104-112, server 114, mobile computing device 115, mobile communications device 118, computer 120, laptop 122, and distributed sensor 124). Bands 104-112 may be implemented with various types of wired and/or wireless communication facilities and are not intended to be limited to any specific technology. For example, data may be transferred from bands 104-112 using an analog audio plug (e.g., TRRS, TRS, or others). In other examples, wireless communication facilities using various types of data communication protocols (e.g., WiFi, Bluetooth®, ZigBee®, ANT™, and others) may be implemented as part of bands 104-112, which may include circuitry, firmware, hardware, radios, antennas, processors, microprocessors, memories, or other electrical, electronic, mechanical, or physical elements configured to enable data communication capabilities of various types and characteristics.

As data-capable devices, bands 104-112 may be configured to collect data from a wide range of sources, including onboard (not shown) and distributed sensors (e.g., server 114, mobile computing device 115, mobile communications device 118, computer 120, laptop 122, and distributed sensor 124) or other bands. Some or all data captured may be personal, sensitive, or confidential and various techniques for providing secure storage and access may be implemented. For example, various types of security protocols and algorithms may be used to encode data stored or accessed by bands 104-112. Examples of security protocols and algorithms include authentication, encryption, encoding, private and public key infrastructure, passwords, checksums, hash codes and hash functions (e.g., SHA, SHA-1, MD-5, and the like), or others may be used to prevent undesired access to data captured by bands 104-112. In other examples, data security for bands 104-112 may be implemented differently.

Bands 104-112 may be used as personal wearable, data capture devices that, when worn, are configured to identify a specific, individual user. By evaluating captured data such as motion data from an accelerometer, biometric data such as heart rate, skin galvanic response, and other biometric data, and using analysis techniques, both long and short-term (e.g., software packages or modules of any type, without limitation), a user may have a unique pattern of behavior or motion and/or biometric responses that can be used as a signature for identification. For example, bands 104-112 may gather data regarding an individual person's gait or other unique biometric, physiological or behavioral characteristics. Using, for example, distributed sensor 124, a biometric signature (e.g., fingerprint, retinal or iris vascular pattern, or others) may be gathered and transmitted to bands 104-112 that, when combined with other data, determines that a given user has been properly identified and, as such, authenticated. When bands 104-112 are worn, a user may be identified and authenticated to enable a variety of other functions such as accessing or modifying data, enabling wired or wireless data transmission facilities (i.e., allowing the transfer of data from bands 104-112 using, for example, various types of wireless data communication protocols such as Near Field Communication (NFC), WiFi, Bluetooth, Zigbee, and others, without limitation), modifying functionality or functions of bands 104-112, authenticating financial transactions using stored data and information (e.g., credit card, PIN, card security numbers, and the like), running applications that allow for various operations to be performed (e.g., controlling physical security and access by transmitting a security code to a reader that, when authenticated, unlocks a door by turning off current to an electromagnetic lock, and others), and others. Different functions and operations beyond those described may be performed using bands 104-112, which can act as secure, personal, wearable, data-capable devices. The number, type, function, configuration, specifications, structure, or other features of system 100 and the above-described elements may be varied and are not limited to the examples provided.

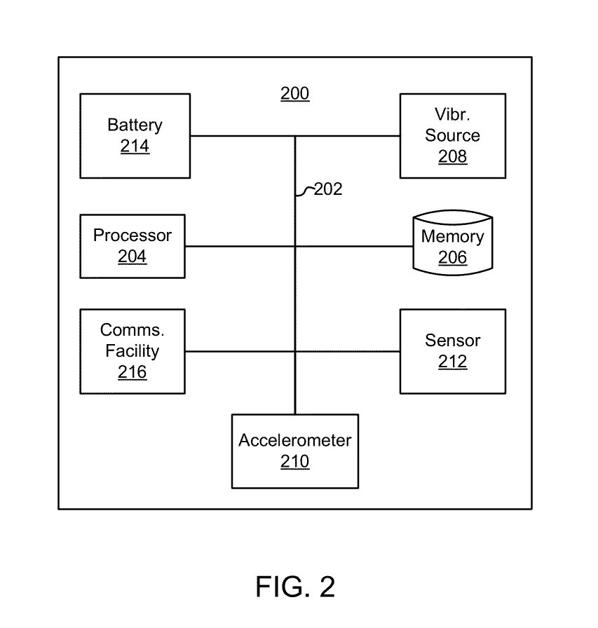

FIG. 2 illustrates a block diagram of an exemplary data-capable strapband. Here, band 200 includes bus 202, processor 204, memory 206, vibration source 208, accelerometer 210, sensor 212, battery 214, and communications facility 216. In some examples, the quantity, type, function, structure, and configuration of band 200 and the elements (e.g., bus 202, processor 204, memory 206, vibration source 208, accelerometer 210, sensor 212, battery 214, and communications facility 216) shown may be varied and are not limited to the examples provided. As shown, processor 204 may be implemented as logic to provide control functions and signals to memory 206, vibration source 208, accelerometer 210, sensor 212, battery 214, and communications facility 216. Processor 204 may be implemented using any type of processor or microprocessor suitable for packaging within bands 104-112 (FIG. 1). Various types of microprocessors may be used to provide data processing capabilities for band 200 and are not limited to any specific type or capability. For example, a MSP430F5528-type microprocessor manufactured by Texas Instruments of Dallas, Tex. may be configured for data communication using audio tones and enabling the use of an audio plug-and-jack system (e.g., TRRS, TRS, or others) for transferring data captured by band 200. Further, different processors may be desired if other functionality (e.g., the type and number of sensors (e.g., sensor 212)) are varied. Data processed by processor 204 may be stored using, for example, memory 206.

In some examples, memory 206 may be implemented using various types of data storage technologies and standards, including, without limitation, read-only memory (“ROM”), random access memory (“RAM”), dynamic random access memory (“DRAM”), static random access memory (“SRAM”), static/dynamic random access memory (“SDRAM”), magnetic random access memory (“MRAM”), solid state, two and three-dimensional memories, Flash®, and others. Memory 206 may also be implemented using one or more partitions that are configured for multiple types of data storage technologies to allow for non-modifiable (i.e., by a user) software to be installed (e.g., firmware installed on ROM) while also providing for storage of captured data and applications using, for example, RAM. Once captured and/or stored in memory 206, data may be subjected to various operations performed by other elements of band 200.

Vibration source 208, in some examples, may be implemented as a motor or other mechanical structure that functions to provide vibratory energy that is communicated through band 200. As an example, an application stored on memory 206 may be configured to monitor a clock signal from processor 204 in order to provide timekeeping functions to band 200. If an alarm is set for a desired time, vibration source 208 may be used to vibrate when the desired time occurs. As another example, vibration source 208 may be coupled to a framework (not shown) or other structure that is used to translate or communicate vibratory energy throughout the physical structure of band 200. In other examples, vibration source 208 may be implemented differently.

Power may be stored in battery 214, which may be implemented as a battery, battery module, power management module, or the like. Power may also be gathered from local power sources such as solar panels, thermo-electric generators, and kinetic energy generators, among others that are alternatives power sources to external power for a battery. These additional sources can either power the system directly or charge a battery that is used to power the system (e.g., of a strapband). In other words, battery 214 may include a rechargeable, expendable, replaceable, or other type of battery, but also circuitry, hardware, or software that may be used in connection with in lieu of processor 204 in order to provide power management, charge/recharging, sleep, or other functions. Further, battery 214 may be implemented using various types of battery technologies, including Lithium Ion (“LI”), Nickel Metal Hydride (“NiMH”), or others, without limitation. Power drawn as electrical current may be distributed from battery via bus 202, the latter of which may be implemented as deposited or formed circuitry or using other forms of circuits or cabling, including flexible circuitry. Electrical current distributed from battery 204 and managed by processor 204 may be used by one or more of memory 206, vibration source 208, accelerometer 210, sensor 212, or communications facility 216.

As shown, various sensors may be used as input sources for data captured by band 200. For example, accelerometer 210 may be used to gather data measured across one, two, or three axes of motion. In addition to accelerometer 210, other sensors (i.e., sensor 212) may be implemented to provide temperature, environmental, physical, chemical, electrical, or other types of sensed inputs. As presented here, sensor 212 may include one or multiple sensors and is not intended to be limiting as to the quantity or type of sensor implemented. Data captured by band 200 using accelerometer 210 and sensor 212 or data requested from another source (i.e., outside of band 200) may also be exchanged, transferred, or otherwise communicated using communications facility 216. As used herein, “facility” refers to any, some, or all of the features and structures that are used to implement a given set of functions. For example, communications facility 216 may include a wireless radio, control circuit or logic, antenna, transceiver, receiver, transmitter, resistors, diodes, transistors, or other elements that are used to transmit and receive data from band 200. In some examples, communications facility 216 may be implemented to provide a “wired” data communication capability such as an analog or digital attachment, plug, jack, or the like to allow for data to be transferred. In other examples, communications facility 216 may be implemented to provide a wireless data communication capability to transmit digitally encoded data across one or more frequencies using various types of data communication protocols, without limitation. In still other examples, band 200 and the above-described elements may be varied in function, structure, configuration, or implementation and are not limited to those shown and described.

FIG. 3 illustrates sensors for use with an exemplary data-capable strapband. Sensor 212 may be implemented using various types of sensors, some of which are shown. Like-numbered and named elements may describe the same or substantially similar element as those shown in other descriptions. Here, sensor 212 (FIG. 2) may be implemented as accelerometer 302, altimeter/barometer 304, light/infrared (“IR”) sensor 306, pulse/heart rate (“HR”) monitor 308, audio sensor (e.g., microphone, transducer, or others) 310, pedometer 312, velocimeter 314, GPS receiver 316, location-based service sensor (e.g., sensor for determining location within a cellular or micro-cellular network, which may or may not use GPS or other satellite constellations for fixing a position) 318, motion detection sensor 320, environmental sensor 322, chemical sensor 324, electrical sensor 326, or mechanical sensor 328.

As shown, accelerometer 302 may be used to capture data associated with motion detection along 1, 2, or 3-axes of measurement, without limitation to any specific type of specification of sensor. Accelerometer 302 may also be implemented to measure various types of user motion and may be configured based on the type of sensor, firmware, software, hardware, or circuitry used. As another example, altimeter/barometer 304 may be used to measure environment pressure, atmospheric or otherwise, and is not limited to any specification or type of pressure-reading device. In some examples, altimeter/barometer 304 may be an altimeter, a barometer, or a combination thereof. For example, altimeter/barometer 304 may be implemented as an altimeter for measuring above ground level (“AGL”) pressure in band 200, which has been configured for use by naval or military aviators. As another example, altimeter/barometer 304 may be implemented as a barometer for reading atmospheric pressure for marine-based applications. In other examples, altimeter/barometer 304 may be implemented differently.

Other types of sensors that may be used to measure light or photonic conditions include light/IR sensor 306, motion detection sensor 320, and environmental sensor 322, the latter of which may include any type of sensor for capturing data associated with environmental conditions beyond light. Further, motion detection sensor 320 may be configured to detect motion using a variety of techniques and technologies, including, but not limited to comparative or differential light analysis (e.g., comparing foreground and background lighting), sound monitoring, or others. Audio sensor 310 may be implemented using any type of device configured to record or capture sound.

In some examples, pedometer 312 may be implemented using devices to measure various types of data associated with pedestrian-oriented activities such as running or walking Footstrikes, stride length, stride length or interval, time, and other data may be measured. Velocimeter 314 may be implemented, in some examples, to measure velocity (e.g., speed and directional vectors) without limitation to any particular activity. Further, additional sensors that may be used as sensor 212 include those configured to identify or obtain location-based data. For example, GPS receiver 316 may be used to obtain coordinates of the geographic location of band 200 using, for example, various types of signals transmitted by civilian and/or military satellite constellations in low, medium, or high earth orbit (e.g., “LEO,” “MEO,” or “GEO”). In other examples, differential GPS algorithms may also be implemented with GPS receiver 316, which may be used to generate more precise or accurate coordinates. Still further, location-based services sensor 318 may be implemented to obtain location-based data including, but not limited to location, nearby services or items of interest, and the like. As an example, location-based services sensor 318 may be configured to detect an electronic signal, encoded or otherwise, that provides information regarding a physical locale as band 200 passes. The electronic signal may include, in some examples, encoded data regarding the location and information associated therewith. Electrical sensor 326 and mechanical sensor 328 may be configured to include other types (e.g., haptic, kinetic, piezoelectric, piezomechanical, pressure, touch, thermal, and others) of sensors for data input to band 200, without limitation. Other types of sensors apart from those shown may also be used, including magnetic flux sensors such as solid-state compasses and the like, including gyroscopic sensors. While the present illustration provides numerous examples of types of sensors that may be used with band 200 (FIG. 2), others not shown or described may be implemented with or as a substitute for any sensor shown or described.

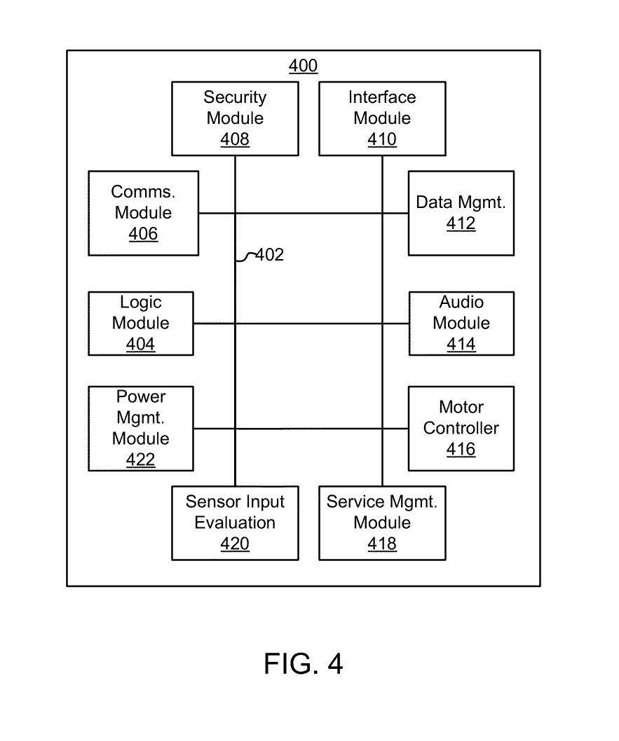

FIG. 4 illustrates an application architecture for an exemplary data-capable strapband. Here, application architecture 400 includes bus 402, logic module 404, communications module 406, security module 408, interface module 410, data management 412, audio module 414, motor controller 416, service management module 418, sensor input evaluation module 420, and power management module 422. In some examples, application architecture 400 and the above-listed elements (e.g., bus 402, logic module 404, communications module 406, security module 408, interface module 410, data management 412, audio module 414, motor controller 416, service management module 418, sensor input evaluation module 420, and power management module 422) may be implemented as software using various computer programming and formatting languages such as Java, C++, C, and others. As shown here, logic module 404 may be firmware or application software that is installed in memory 206 (FIG. 2) and executed by processor 204 (FIG. 2). Included with logic module 404 may be program instructions or code (e.g., source, object, binary executables, or others) that, when initiated, called, or instantiated, perform various functions.

For example, logic module 404 may be configured to send control signals to communications module 406 in order to transfer, transmit, or receive data stored in memory 206, the latter of which may be managed by a database management system (“DBMS”) or utility in data management module 412. As another example, security module 408 may be controlled by logic module 404 to provide encoding, decoding, encryption, authentication, or other functions to band 200 (FIG. 2). Alternatively, security module 408 may also be implemented as an application that, using data captured from various sensors and stored in memory 206 (and accessed by data management module 412) may be used to provide identification functions that enable band 200 to passively identify a user or wearer of band 200. Still further, various types of security software and applications may be used and are not limited to those shown and described.

Interface module 410, in some examples, may be used to manage user interface controls such as switches, buttons, or other types of controls that enable a user to manage various functions of band 200. For example, a 4-position switch may be turned to a given position that is interpreted by interface module 410 to determine the proper signal or feedback to send to logic module 404 in order to generate a particular result. In other examples, a button (not shown) may be depressed that allows a user to trigger or initiate certain actions by sending another signal to logic module 404. Still further, interface module 410 may be used to interpret data from, for example, accelerometer 210 (FIG. 2) to identify specific movement or motion that initiates or triggers a given response. In other examples, interface module 410 may be used to manage different types of displays (e.g., light-emitting diodes (LEDs), interferometric modulator display (IMOD), electrophoretic ink (E Ink), organic light-emitting diode (OLED), etc.). In other examples, interface module 410 may be implemented differently in function, structure, or configuration and is not limited to those shown and described.

As shown, audio module 414 may be configured to manage encoded or unencoded data gathered from various types of audio sensors. In some examples, audio module 414 may include one or more codecs that are used to encode or decode various types of audio waveforms. For example, analog audio input may be encoded by audio module 414 and, once encoded, sent as a signal or collection of data packets, messages, segments, frames, or the like to logic module 404 for transmission via communications module 406. In other examples, audio module 414 may be implemented differently in function, structure, configuration, or implementation and is not limited to those shown and described. Other elements that may be used by band 200 include motor controller 416, which may be firmware or an application to control a motor or other vibratory energy source (e.g., vibration source 208 (FIG. 2)). Power used for band 200 may be drawn from battery 214 (FIG. 2) and managed by power management module 422, which may be firmware or an application used to manage, with or without user input, how power is consumer, conserved, or otherwise used by band 200 and the above-described elements, including one or more sensors (e.g., sensor 212 (FIG. 2), sensors 302-328 (FIG. 3)). With regard to data captured, sensor input evaluation module 420 may be a software engine or module that is used to evaluate and analyze data received from one or more inputs (e.g., sensors 302-328) to band 200. When received, data may be analyzed by sensor input evaluation module 420, which may include custom or “off-the-shelf” analytics packages that are configured to provide application-specific analysis of data to determine trends, patterns, and other useful information. In other examples, sensor input module 420 may also include firmware or software that enables the generation of various types and formats of reports for presenting data and any analysis performed thereupon.

Another element of application architecture 400 that may be included is service management module 418. In some examples, service management module 418 may be firmware, software, or an application that is configured to manage various aspects and operations associated with executing software-related instructions for band 200. For example, libraries or classes that are used by software or applications on band 200 may be served from an online or networked source. Service management module 418 may be implemented to manage how and when these services are invoked in order to ensure that desired applications are executed properly within application architecture 400. As discrete sets, collections, or groupings of functions, services used by band 200 for various purposes ranging from communications to operating systems to call or document libraries may be managed by service management module 418. Alternatively, service management module 418 may be implemented differently and is not limited to the examples provided herein. Further, application architecture 400 is an example of a software/system/application-level architecture that may be used to implement various software-related aspects of band 200 and may be varied in the quantity, type, configuration, function, structure, or type of programming or formatting languages used, without limitation to any given example.

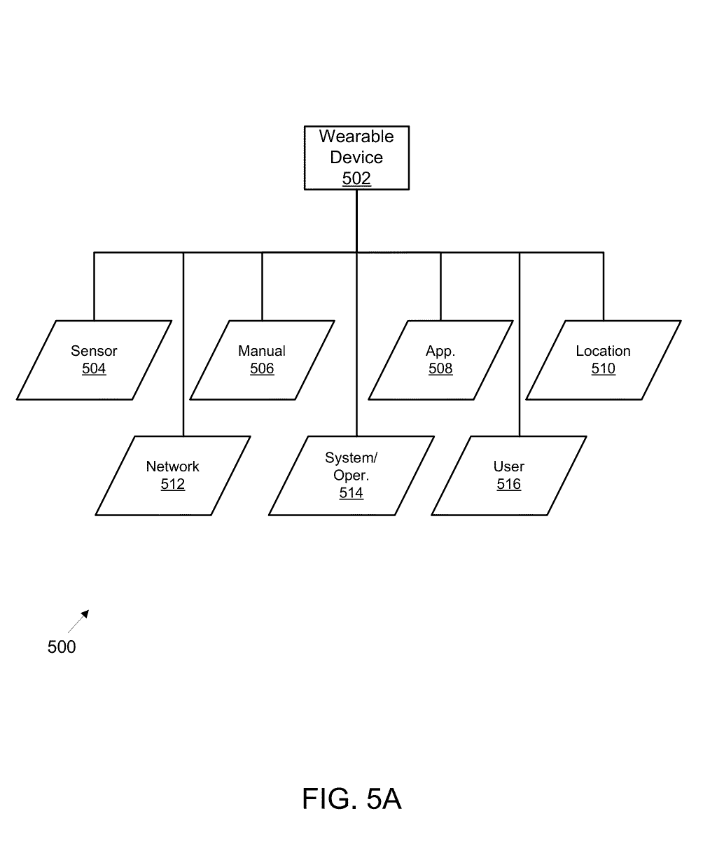

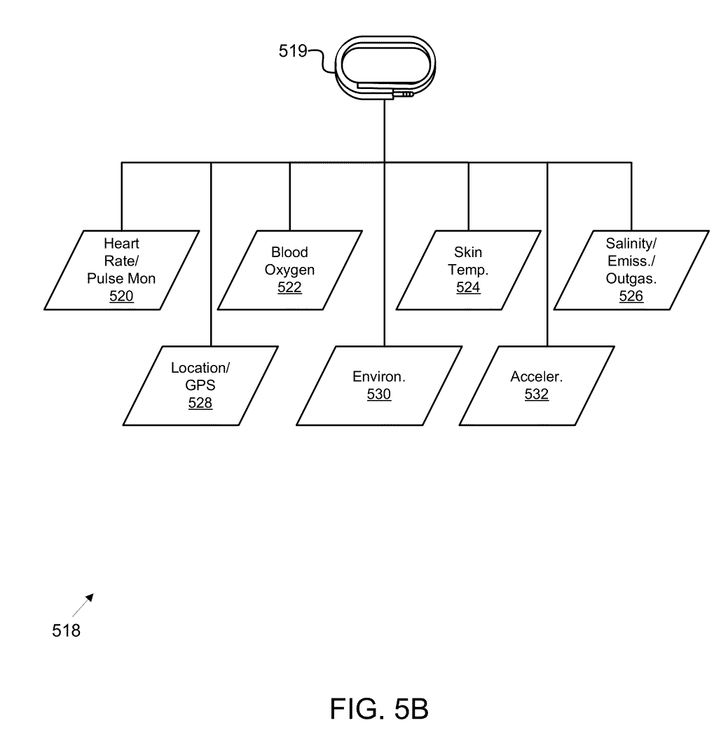

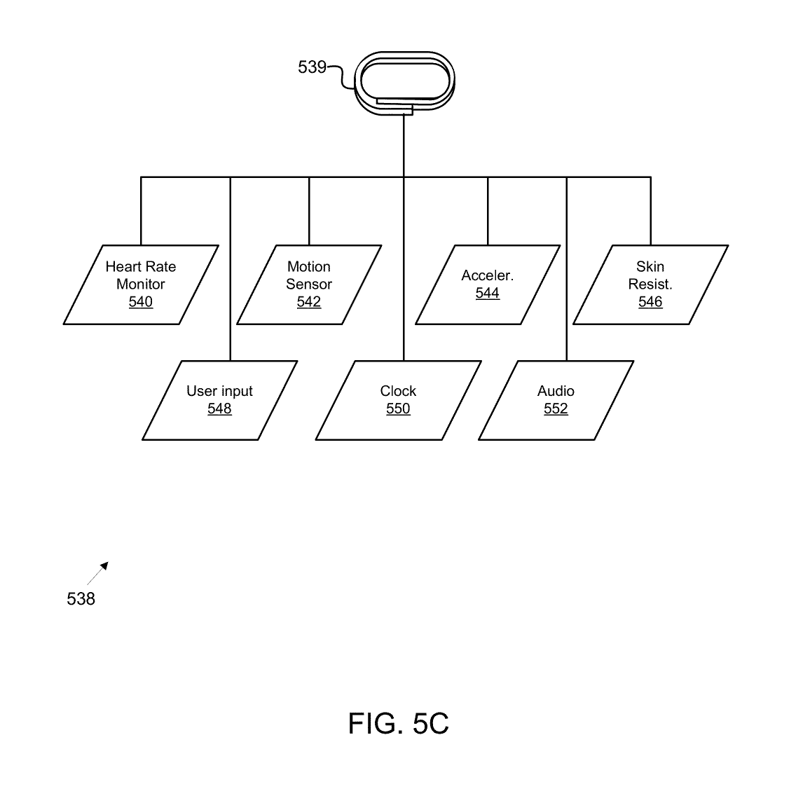

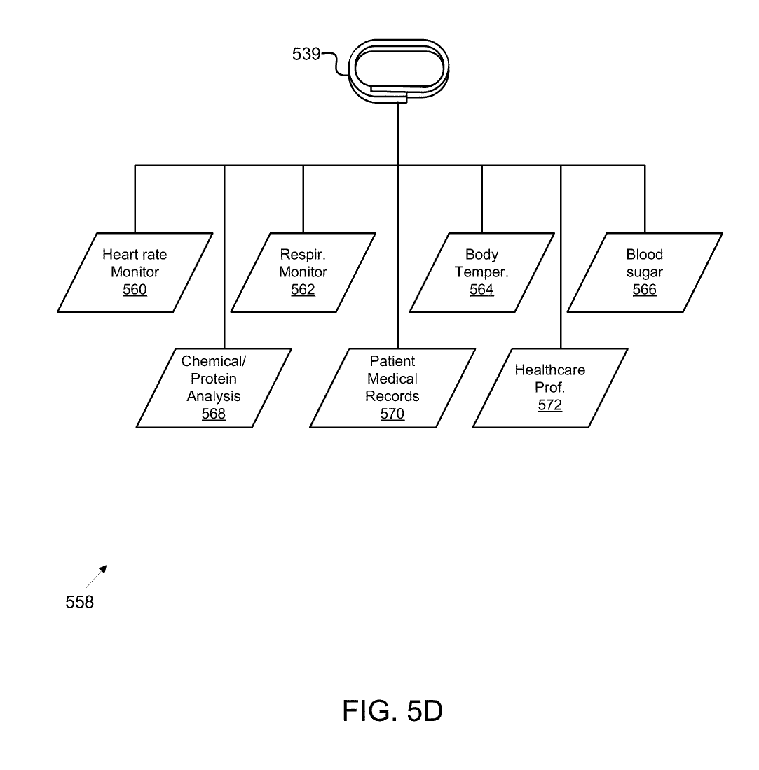

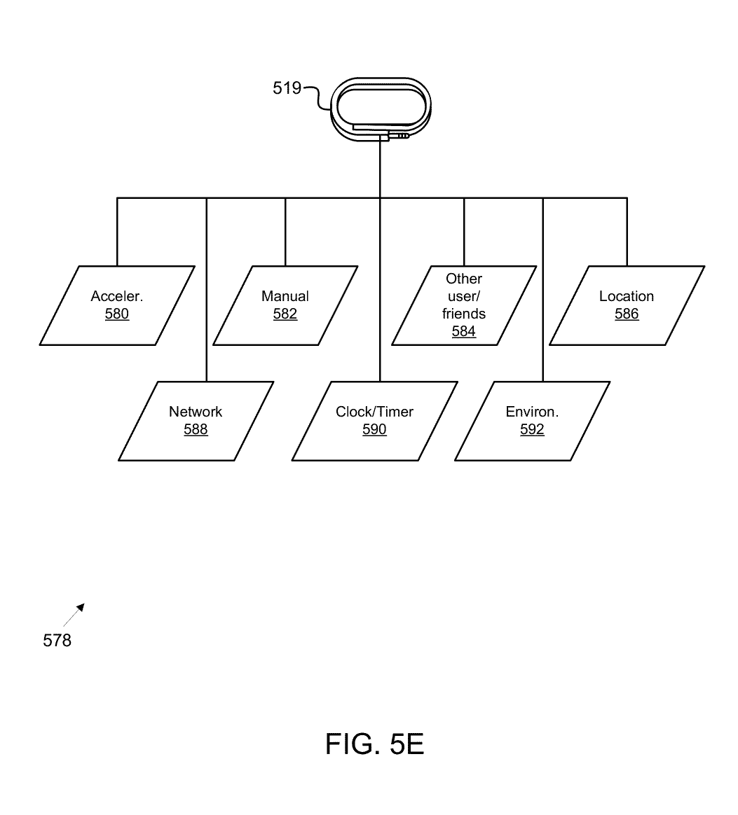

FIG. 5A illustrates representative data types for use with an exemplary data-capable strapband. Here, wearable device 502 may capture various types of data, including, but not limited to sensor data 504, manually-entered data 506, application data 508, location data 510, network data 512, system/operating data 514, and user data 516. In some examples, wearable device 502 may be implemented as a watch band or strap that is directly or indirectly coupled to a watch, watch face, or other timepiece (i.e., a timepiece, in some examples, may be any type, design, layout, structure, style, or other type of implementation that is configured to determine a time and, in other examples, may be configured to provide other features or functionality such as an altimeter, barometric pressure sensor, stop watch, lap counter, or others, without limitation). When coupled to a given watch, any and all features or functionality described or otherwise envisioned by one of ordinary skill in the art, may be integrated, incorporated, or otherwise implemented within a band that may be used as a watch band, either manufactured, designed, or styled for a given type of watch or as a replacement band that may be used to replace an original watch band that is uncoupled or detached from a given watch or timepiece. Further, features and functions such as those described herein for gathering various types of data may be implemented using various types of sensors, including, but not limited to, sensors for heart rate monitoring, motion sensing, accelerometers, temperature sensing, galvanic skin response (GSR), and numerous others, without limitation. In other examples, features and functionality such as those described in the data-capable strap bands, watch bands, and other types of wearable devices such as those described herein may be implemented by coupling to a watch, directly or indirectly. In other examples, features or functionality incorporated with a watch may also be combined with those of a watch band (such as the techniques described above) to yield a greater range of capability for a given watch band. For example, a data-capable strapband may be implemented as a watch band and, when coupled to a watch, may receive input from the watch as an additive provider of sensory input. In other words, a watch and a data-capable strapband, such as those described herein, may be coupled directly or indirectly, wired or wirelessly together and, when placed in such states or proximity, may be used to transfer data between each other or to share or distribute functions or functionality so as to implement a monolithic “watch”-type device or system. In still other examples, wearable device 502 may be implemented differently and is not limited to those examples shown or described herein.

Various types of data may be captured from sensors, such as those described above in connection with FIG. 3. Manually-entered data, in some examples, may be data or inputs received directly and locally by band 200 (FIG. 2). In other examples, manually-entered data may also be provided through a third-party website that stores the data in a database and may be synchronized from server 114 (FIG. 1) with one or more of bands 104-112. Other types of data that may be captured including application data 508 and system/operating data 514, which may be associated with firmware, software, or hardware installed or implemented on band 200. Further, location data 510 may be used by wearable device 502, as described above. User data 516, in some examples, may be data that include profile data, preferences, rules, or other information that has been previously entered by a given user of wearable device 502. Further, network data 512 may be data is captured by wearable device with regard to routing tables, data paths, network or access availability (e.g., wireless network access availability), and the like. Other types of data may be captured by wearable device 502 and are not limited to the examples shown and described. Additional context-specific examples of types of data captured by bands 104-112 (FIG. 1) are provided below.

FIG. 5B illustrates representative data types for use with an exemplary data-capable strapband in fitness-related activities. Here, band 519 may be configured to capture types (i.e., categories) of data such as heart rate/pulse monitoring data 520, blood oxygen level data 522, skin temperature data 524, salinity/emission/outgassing data 526, location/GPS data 528, environmental data 530, and accelerometer data 532. As an example, a runner may use or wear band 519 to obtain data associated with his physiological condition (i.e., heart rate/pulse monitoring data 520, skin temperature, salinity/emission/outgassing data 526, among others), athletic efficiency (i.e., blood oxygen level data 522), and performance (i.e., location/GPS data 528 (e.g., distance or laps run), environmental data 530 (e.g., ambient temperature, humidity, pressure, and the like), accelerometer 532 (e.g., biomechanical information, including gait, stride, stride length, among others)). Other or different types of data may be captured by band 519, but the above-described examples are illustrative of some types of data that may be captured by band 519. Further, data captured may be uploaded to a website or online/networked destination for storage and other uses. For example, fitness-related data may be used by applications that are downloaded from a “fitness marketplace” where athletes may find, purchase, or download applications for various uses. Some applications may be activity-specific and thus may be used to modify or alter the data capture capabilities of band 519 accordingly. For example, a fitness marketplace may be a website accessible by various types of mobile and non-mobile clients to locate applications for different exercise or fitness categories such as running, swimming, tennis, golf, baseball, football, fencing, and many others. When downloaded, a fitness marketplace may also be used with user-specific accounts to manage the retrieved applications as well as usage with band 519, or to use the data to provide services such as online personal coaching or targeted advertisements. More, fewer, or different types of data may be captured for fitness-related activities.

FIG. 5C illustrates representative data types for use with an exemplary data-capable strapband in sleep management activities. Here, band 539 may be used for sleep management purposes to track various types of data, including heart rate monitoring data 540, motion sensor data 542, accelerometer data 544, skin resistivity data 546, user input data 548, clock data 550, and audio data 552. In some examples, heart rate monitor data 540 may be captured to evaluate rest, waking, or various states of sleep. Motion sensor data 542 and accelerometer data 544 may be used to determine whether a user of band 539 is experiencing a restful or fitful sleep. For example, some motion sensor data 542 may be captured by a light sensor that measures ambient or differential light patterns in order to determine whether a user is sleeping on her front, side, or back. Accelerometer data 544 may also be captured to determine whether a user is experiencing gentle or violent disruptions when sleeping, such as those often found in afflictions of sleep apnea or other sleep disorders. Further, skin resistivity data 546 may be captured to determine whether a user is ill (e.g., running a temperature, sweating, experiencing chills, clammy skin, and others). Still further, user input data may include data input by a user as to how and whether band 539 should trigger vibration source 208 (FIG. 2) to wake a user at a given time or whether to use a series of increasing or decreasing vibrations to trigger a waking state. Clock data (550) may be used to measure the duration of sleep or a finite period of time in which a user is at rest. Audio data may also be captured to determine whether a user is snoring and, if so, the frequencies and amplitude therein may suggest physical conditions that a user may be interested in knowing (e.g., snoring, breathing interruptions, talking in one's sleep, and the like). More, fewer, or different types of data may be captured for sleep management-related activities.

FIG. 5D illustrates representative data types for use with an exemplary data-capable strapband in medical-related activities. Here, band 539 may also be configured for medical purposes and related-types of data such as heart rate monitoring data 560, respiratory monitoring data 562, body temperature data 564, blood sugar data 566, chemical protein/analysis data 568, patient medical records data 570, and healthcare professional (e.g., doctor, physician, registered nurse, physician's assistant, dentist, orthopedist, surgeon, and others) data 572. In some examples, data may be captured by band 539 directly from wear by a user. For example, band 539 may be able to sample and analyze sweat through a salinity or moisture detector to identify whether any particular chemicals, proteins, hormones, or other organic or inorganic compounds are present, which can be analyzed by band 539 or communicated to server 114 to perform further analysis. If sent to server 114, further analyses may be performed by a hospital or other medical facility using data captured by band 539. In other examples, more, fewer, or different types of data may be captured for medical-related activities.

FIG. 5E illustrates representative data types for use with an exemplary data-capable strapband in social media/networking-related activities. Examples of social media/networking-related activities include related to Internet-based Social Networking Services (“SNS”), such as Facebook®, Twitter®, etc. Here, band 519, shown with an audio data plug, may be configured to capture data for use with various types of social media and networking-related services, websites, and activities. Accelerometer data 580, manual data 582, other user/friends data 584, location data 586, network data 588, clock/timer data 590, and environmental data 592 are examples of data that may be gathered and shared by, for example, uploading data from band 519 using, for example, an audio plug such as those described herein. As another example, accelerometer data 580 may be captured and shared with other users to share motion, activity, or other movement-oriented data. Manual data 582 may be data that a given user also wishes to share with other users. Likewise, other user/friends data 584 may be from other bands (not shown) that can be shared or aggregated with data captured by band 519. Location data 586 for band 519 may also be shared with other users. In other examples, a user may also enter manual data 582 to prevent other users or friends from receiving updated location data from band 519. Additionally, network data 588 and clock/timer data may be captured and shared with other users to indicate, for example, activities or events that a given user (i.e., wearing band 519) was engaged at certain locations. Further, if a user of band 519 has friends who are not geographically located in close or near proximity (e.g., the user of band 519 is located in San Francisco and her friend is located in Rome), environmental data can be captured by band 519 (e.g., weather, temperature, humidity, sunny or overcast (as interpreted from data captured by a light sensor and combined with captured data for humidity and temperature), among others). In other examples, more, fewer, or different types of data may be captured for medical-related activities.

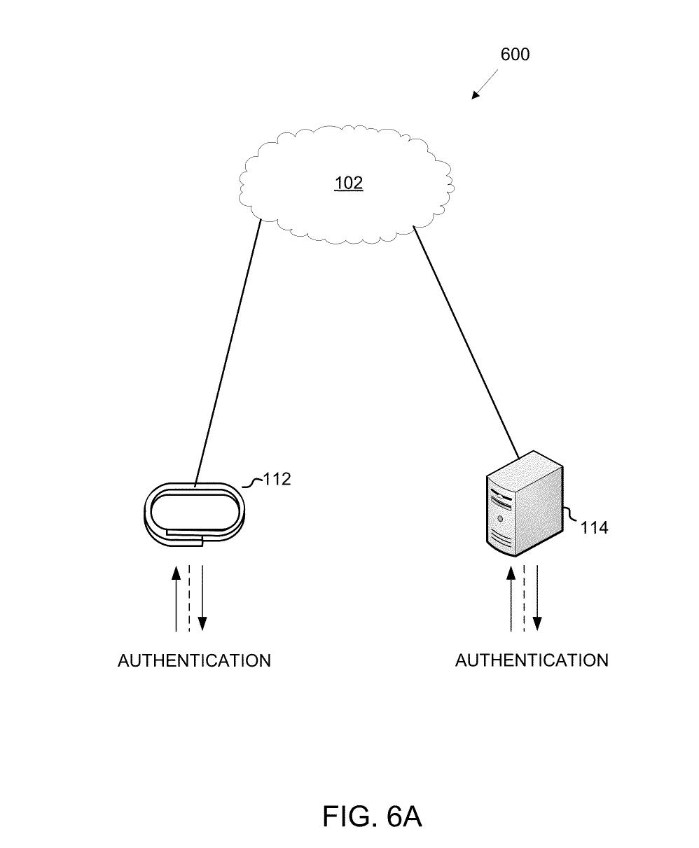

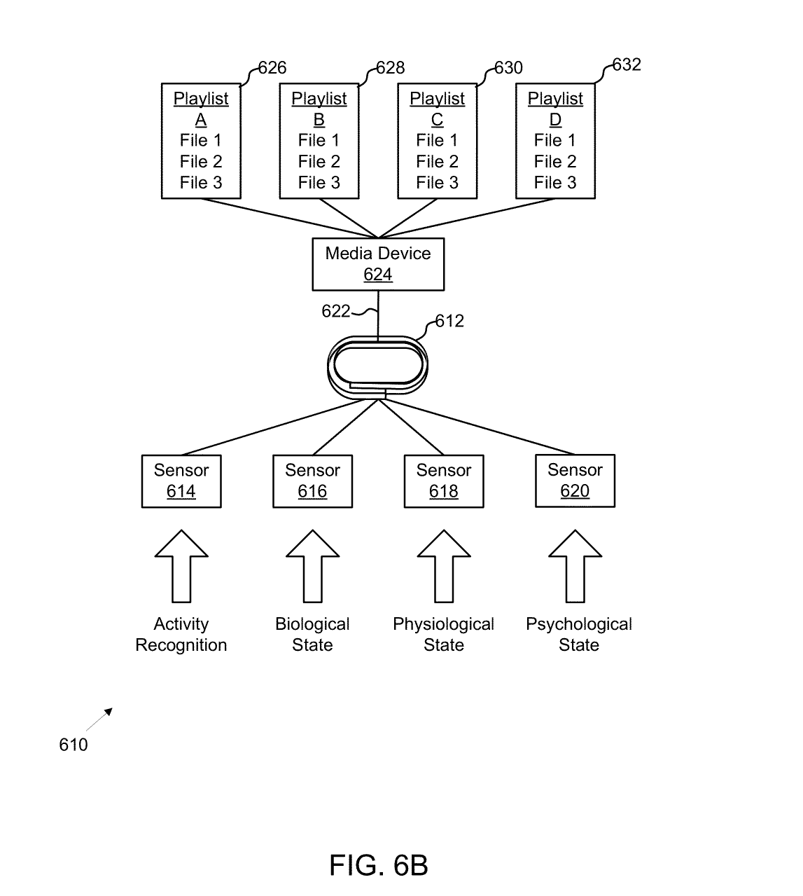

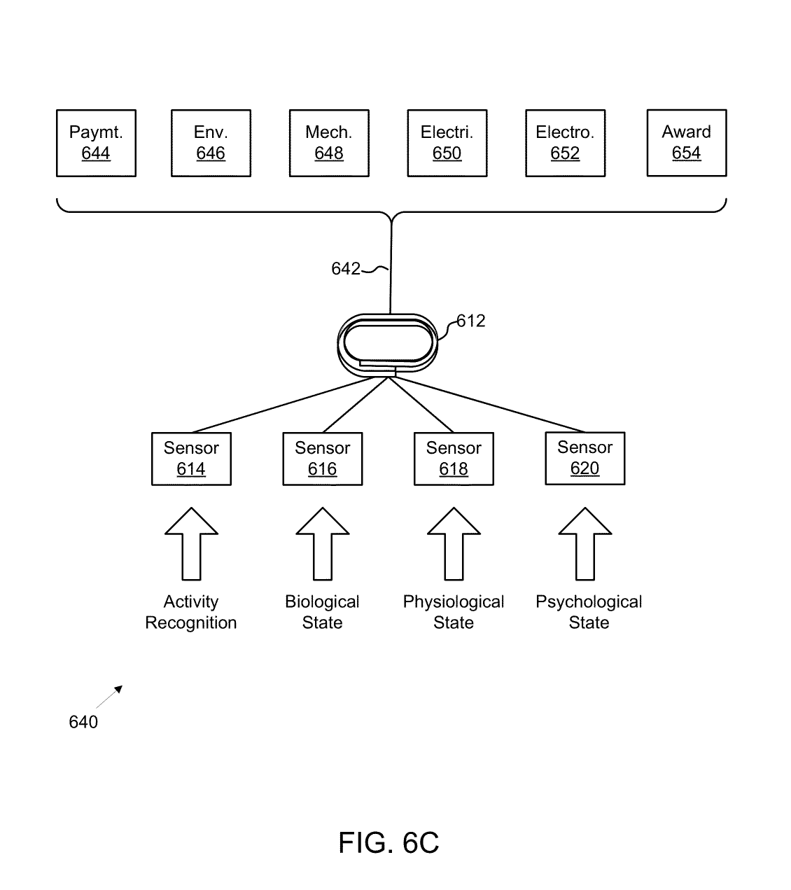

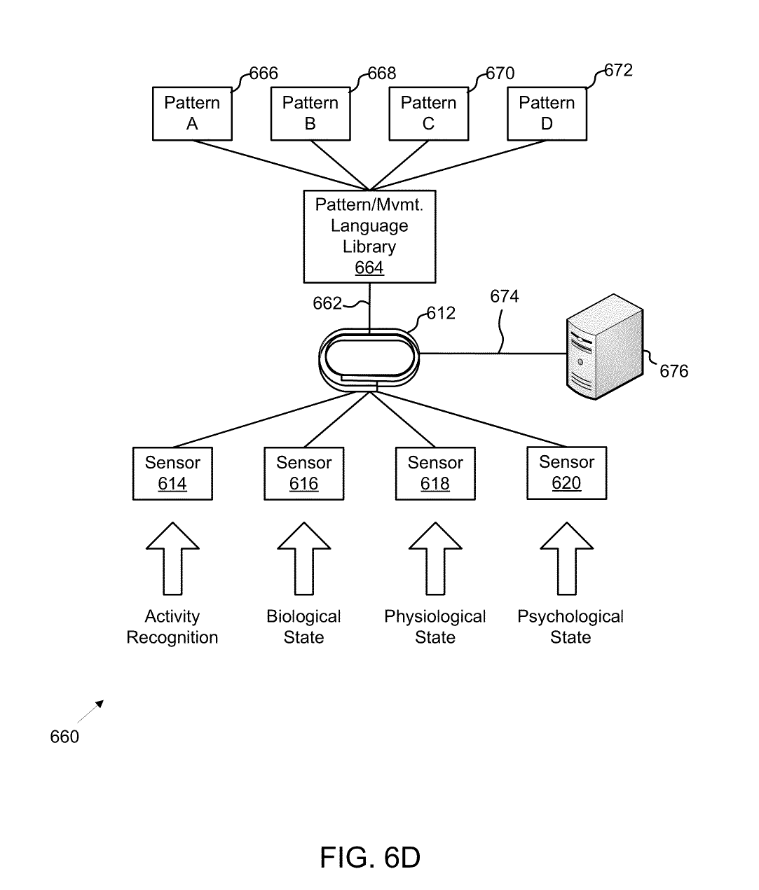

FIG. 6A illustrates an exemplary system for wearable device data security. Exemplary system 600 comprises network 102, band 112, and server 114. As described above, band 112 may capture data that is personal, sensitive, or confidential. In some examples, security protocols and algorithms, as described above, may be implemented on band 112 to authenticate a user's identity. This authentication may be implemented to prevent unwanted use or access by others. In other examples, the security protocols and algorithms may be performed by server 114, in which case band 112 may communicate with server 114 via network 102 to authenticate a user's identity. Use of the band to capture, evaluate or access a user's data may be predicated on authentication of the user's identity.

In some examples, band 112 may identify of a user by the user's unique pattern of behavior or motion. Band 112 may capture and evaluate data from a user to create a unique key personal to the user. The key may be associated with an individual user's physical attributes, including gait, biometric or physiological signatures (e.g., resting heart rate, skin temperature, salinity of emitted moisture, etc.), or any other sets of data that may be captured by band 112, as described in more detail above. The key may be based upon a set of physical attributes that are known in combination to be unique to a user. Once the key is created based upon the predetermined, or pre-programmed, set of physical attributes, it may be used in an authentication process to authenticate a user's identity, and prevent access to, or capture and evaluation of, data by an unauthorized user. In some examples, authentication using the key may be carried out directly by band 112. In other examples, band 112 may be used to authenticate with other bands (not shown) that may be owned by the same individual (i.e., user). Multiple bands, for example, that are owned by the same individual may be configured for different sensors or types of activities, but may also be configured to share data between them. In order to prevent unauthenticated or unauthorized individuals from accessing a given user's data, band 112 may be configured using various types of authentication, identification, or other security techniques among one or more bands, including band 112. As an example, band 112 may be in direct data communication with other bands (not shown) or indirectly through an authentication system or service, which may be implemented using server 114. In still other examples, band 112 may send data to server 114, which in turn carries out the authentication and returns a prompt or notification to band 112 to unlock band 112 for use. In other examples, data security and identity authentication for band 112 may be implemented differently.

FIG. 6B illustrates an exemplary system for media device, application, and content management using sensory input. Here, system 660 includes band 612, sensors 614-620, data connection 622, media device 624, and playlists 626-632. As used throughout this description, band 612 may also be referred to interchangeably as a “wearable device.” Sensors 614-620 may be implemented using any type of sensor such as a 2 or 3-axis accelerometer, temperature, humidity, barometric pressure, skin resistivity (i.e., galvanic skin response (GSR)), pedometer, or any other type of sensor, without limitation. Data connection 622 may be implemented as any type of wired or wireless connection using any type of data communication protocol (e.g., Bluetooth®, wireless fidelity (i.e., WiFi), LAN, WAN, MAN, near field communication (NFC), or others, without limitation) between band 612 and media device 624. Data connection 622 may be configured to transfer data bi-directionally or in a single direction between media device 624 and band 612. In some examples, data connection 622 may be implemented by using a 3.5 mm audio jack that connects to an appropriate plug (i.e., outlet) and transmits electrical signals that may be interpreted for transferring data. Alternatively, a wireless radio, transmitter, transceiver, or the like may be implemented with band 612 and, when a motion is detected via an installed accelerometer on the band 612, initiates a transmission of a control signal to media device 624 to, for example, begin playing playlist 630, change from one playlist to another, forward to another song on given playlist, and the like.

In some examples, on or more of playlists 626-632 may reside locally (e.g., on media device 624, etc.). In other examples, one or more of playlists 626-632 may be implemented remotely (e.g., in the Cloud, etc.). In some examples, one or more of playlists 626-632 may be created from songs or groups of songs (e.g., other playlists, etc.) that are shared with the user through an SNS, a radio station website, or other remote source. In some examples, one or more of playlists 626-632 may be created using sensory data gathered by band 612. In other examples, one or more of playlists 626-632 may be created using sensory data gathered by other data-capable bands, worn by the user also wearing band 612, or worn by another user.

As shown, media device 624 may be any type of device that is configured to display, play, interact, show, or otherwise present various types of media, including audio, visual, graphical, images, photographical, video, rich media, multimedia, or a combination thereof, without limitation. Examples of media device 624 may include audio playback devices (e.g., players configured to play various formats of audio and video files including .mp3, .wav, and others, without limitation), connected or wireless (e.g., Bluetooth®, WiFi, WLAN, and others) speakers, radios, audio devices installed on portable, desktop, or mobile computing devices, and others. Playlists 626-632 may be configured to play various types of files of any format, as representatively illustrated by “File 1, File 2, File 3” in association with each playlist. Each file on a given playlist may be any type of media and played using various types of formats or applications implemented on media device 624. As described above, these files may reside locally or remotely.

As an example, sensors 614-620 may detect various types of inputs locally (i.e., on band 612) or remotely (i.e., on another device that is in data communication with band 612) such as an activity or motion (e.g., running, walking, swimming, jogging, jumping, shaking, turning, cycling, or others), a biological state (e.g., healthy, ill, diabetic, or others), a physiological state (e.g., normal gait, limping, injured, or others), or a psychological state (e.g., happy, depressed, angry, and the like). Other types of inputs may be sensed by sensors 614-620, which may be configured to gather data and transmit that information to an application that uses the data to infer various conclusions related to the above-described states or activities, among others. Based on the data gathered by sensors 614-620 and, in some examples, user or system-specified parameters, band 612 may be configured to generate control signals (e.g., electrical or electronic signals that are generated at various types of amount of voltage in order to produce, initiate, trigger, or otherwise cause certain actions or functions to occur). For example, data may be transferred from sensors 614-620 to band 612 indicating that a user has started running Band 612 may be configured to generate a control signal to media device 624 over data connection 622 to initiate playing files in a given playlist in order. A shake of a user's wrist, for example, in a given direction or axis may cause band 612 to generate a different control signal that causes media device 624 to change the play order, to change files, to forward to another file, to playback from a different part of the currently played file, or the like. In some examples, a given movement (e.g., a user shakes her wrist (on which band 612 is worn)) may be resolved into data associated with motion occurring along each of 3-different axes. Band 612 may be configured to detect motion using an accelerometer (not shown), which then resolves the detected motion into data associated with three separate axes of movement, translated into data or electrical control signals that may be stored in a memory that is local and/or remote to band 612. Further, the stored data of a given motion may be associated with a specific action such that, when detected, control signals may be generated by band 612 and sent over data connection 622 to media device 624 or other types of devices, without limitation.

As another example, if sensor 616 detects that a user is lying prone and her heart rate is slowing (e.g., decelerating towards a previously-recorded resting heart rate), a control signal may be generated by band 612 to begin playback of Brahms' Lullaby via a Bluetooth®-connected headset speaker (i.e., media device 624). Additionally, if sensor 618 detects a physiological state change (e.g., a user is walking with a gait or limp as opposed to normally observed physiological behavior), media device 624 may be controlled by band 612 to initiate playback of a file on a graphical user interface of a connected device (e.g., a mobile computing or communications device) that provides a tutorial on running injury recovery and prevent. As yet another example, if sensor 620 detects one or more parameters that a user is happy (e.g., sensor 620 detects an accelerated, but regular heart rate, rapid or erratic movements, increased body temperature, increased speech levels, and the like), band 612 may send a control signal to media device 624 to display an inquiry as to whether the user wishes to hear songs played from her “happy playlist” (not shown). The above-described examples are provided for purposes of illustrating the use of managing various types of media and media content using band 612, but many others may be implemented without restriction to those provided.

FIG. 6C illustrates an exemplary system for device control using sensory input. Here, system 640 includes band 612, sensors 614-620, data connection 642, and device types 644-654. Those elements shown that are like-named and numbered may be designed, implemented, or configured as described above or differently. As shown, the detection by band 612 of a given activity, biological state, physiological state, or psychological state may be gathered as data from sensors 614-620 and used to generate various types of control signals. Control signals, in some examples, may be transmitted via a wired or wireless data connection (e.g., data connection 642) to one or multiple device types 644-654 that are in data communication with band 612. Device types 644-654 may be any type of device, apparatus, application, or other mechanism that may be in data connection with, coupled to (indirectly or directly), paired (e.g., via Bluetooth® or another data communication protocol), or otherwise configured to receive control signals from band 612. Various types of devices, including another device that may be in data communication with band 612 (i.e., a wearable device), may be any type of physical, mechanical, electrical, electronic, chemical, biomechanical, biochemical, bioelectrical, or other type of device, without limitation.

As shown, band 612 may send control signals to various types of devices (e.g., device types 644-654), including payment systems (644), environmental (646), mechanical (648), electrical (650), electronic (652), award (654), and others, without limitation. In some examples, band 612 may be associated with an account to which a user may link a credit card, debit card, or other type of payment account that, when properly authenticated, allows for the transmission of data and control signals (not shown) over data connection 642 to payment device 644. In other examples, band 612 may be used to send data that can be translated or interpreted as control signals or voltages in order to manage environmental control systems (e.g., heating, ventilation, air conditioning (HVAC), temperature, air filter (e.g., hepa, pollen, allergen), humidify, and others, without limitation). Input detected from one or more of sensors 614-620 may be transformed into data received by band 612. Using firmware, application software, or other user or system-specified parameters, when data associated with input from sensors 614-620 are received, control signals may be generated and sent by band 612 over data connection 642 to environmental control system 646, which may be configured to implement a change to one or more environmental conditions within, for example, a residential, office, commercial, building, structural, or other type of environment. As an example, if sensor 612 detects that a user wearing band 612 has begun running and sensor 618 detects a rise in one or more physiological conditions, band 612 may generate control signals and send these over data connection 642 to environmental control system 646 to lower the ambient air temperature to a specified threshold (as input by a user into an account storing a profile associated with environmental conditions he prefers for running (or another type of activity)) and decreasing humidity to account for increased carbon dioxide emissions due to labored breathing. As another example, sensor 616 may detect that a given user is pregnant due to the detection of an increase in various types of hormonal levels, body temperature, and other biochemical conditions. Using this input against comparing the user's past preferred ambient temperature ranges, band 612 may be configured to generate, without user input, one or more control signals that may be sent to operate electrical motors that are used to open or close window shades and mechanical systems that are used to open or close windows in order to adjust the ambient temperature inside her home before arriving from work. As a further example, sensor 618 may detect that a user has been physiologically confined to a sitting position for 4 hours and sensor 620 has received input indicating that the user is in an irritated psychological state due to an audio sensor (not shown, but implementable as sensor 620) detecting increased noise levels (possibly, due to shouting or elevating voice levels), a temperature sensor (not shown) detecting an increase in body temperature, and a galvanic skin response sensor (not shown) detecting changes in skin resistivity (i.e., a measure of electrical conductivity of skin). Subsequently, band 612, upon receiving this input, may compare this data against a database (either in firmware or remote over data connection 642) and, based upon this comparison, send a control signal to an electrical system to lower internal lighting and another control signal to an electronic audio system to play calming music from memory, compact disc, or the like.

As another example, a user may have an account associated with band 612 and enrolls in a participatory fitness program that, upon achieving certain milestones, results in the receipt of an award or promotion. For example, sensor 614 may detect that a user has associated his account with a program to receive a promotional discount towards the purchase of a portable Bluetooth® communications headset. However, the promotion may be earned once the user has completed, using band 612, a 10 kilometer run at an 8-minute and 30-second per mile pace. Upon first detecting the completion of this event using input from, for example, a GPS sensor (not shown, but implementable as sensor 614), a pedometer, a clock, and an accelerometer, band 612 may be configured to send a signal or data via a wireless connection (i.e., data connection 642) to award system 654, which may be configured to retrieve the desired promotion from another database (e.g., a promotions database, an advertisement server, an advertisement network, or others) and then send the promotion electronically back to band 612 for further display or use (e.g., redemption) on a device in data connection with band 612 (not shown). Other examples of the above-described device types and other device types not shown or described may be implemented and are not limited to those provided.

FIG. 6D illustrates an exemplary system for movement languages in wearable devices. Here, system 660 includes band 612, sensors 614-620, data connection 622, pattern/movement language library (i.e., pattern library) 664, patterns 666-672, data connection 674, and server 676. In some examples, band 612 may be configured to compile a “movement language” that may be stored in pattern library 664, which can be either locally (i.e., in memory on band 612) or remotely (i.e., in a database or other data storage facility that is in data connection with band 612, either via wired or wireless data connections). As used herein, a “movement language” may refer to the description of a given movement as one or more inputs that may be transformed into a discrete set of data that, when observed again, can be identified as correlating to a given movement. In some examples, a movement may be described as a collection of one or more motions. In other examples, biological, psychological, and physiological states or events may also be recorded in pattern library 664. These various collections of data may be stored in pattern library 664 as patterns 666-672.

A movement, when detected by an accelerometer (not shown) on band 612, may be associated with a given data set and used, for example, to perform one or more functions when detected again. Parameters may be specified (i.e., by either a user or system (i.e., automatically or semi-automatically generated)) that also allow for tolerances to determine whether a given movement falls within a given category (e.g., jumping may be identified as a set of data that has a tolerance of +/−0.5 meters for the given individual along a z-axis as input from a 3-axes accelerometer).

Using the various types of sensors (e.g., sensors 614-620), different movements, motions, moods, emotions, physiological, psychological, or biological events can be monitored, recorded, stored, compared, and used for other functions by band 612. Further, movements may also be downloaded from a remote location (e.g., server 676) to band 612. Input provided by sensors 614-620 and resolved into one or more of patterns 666-672 and used to initiate or perform one or more functions, such as authentication (FIG. 6A), playlist management (FIG. 6B), device control (FIG. 6C), among others. In other examples, systems 610, 640, 660 and the respective above-described elements may be varied in design, implementation, configuration, function, structure, or other aspects and are not limited to those provided.

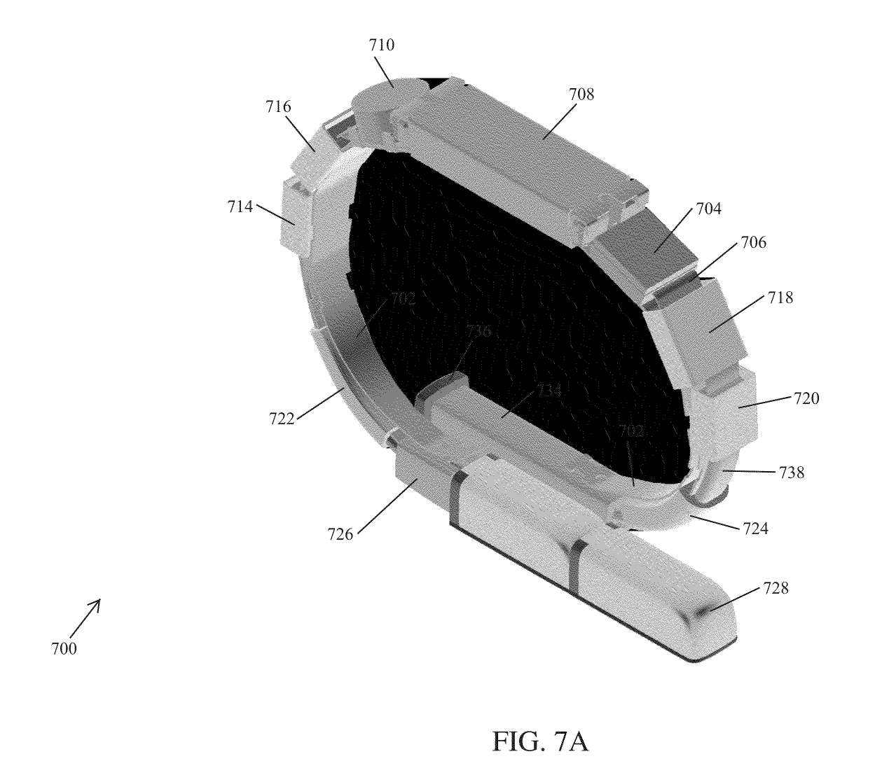

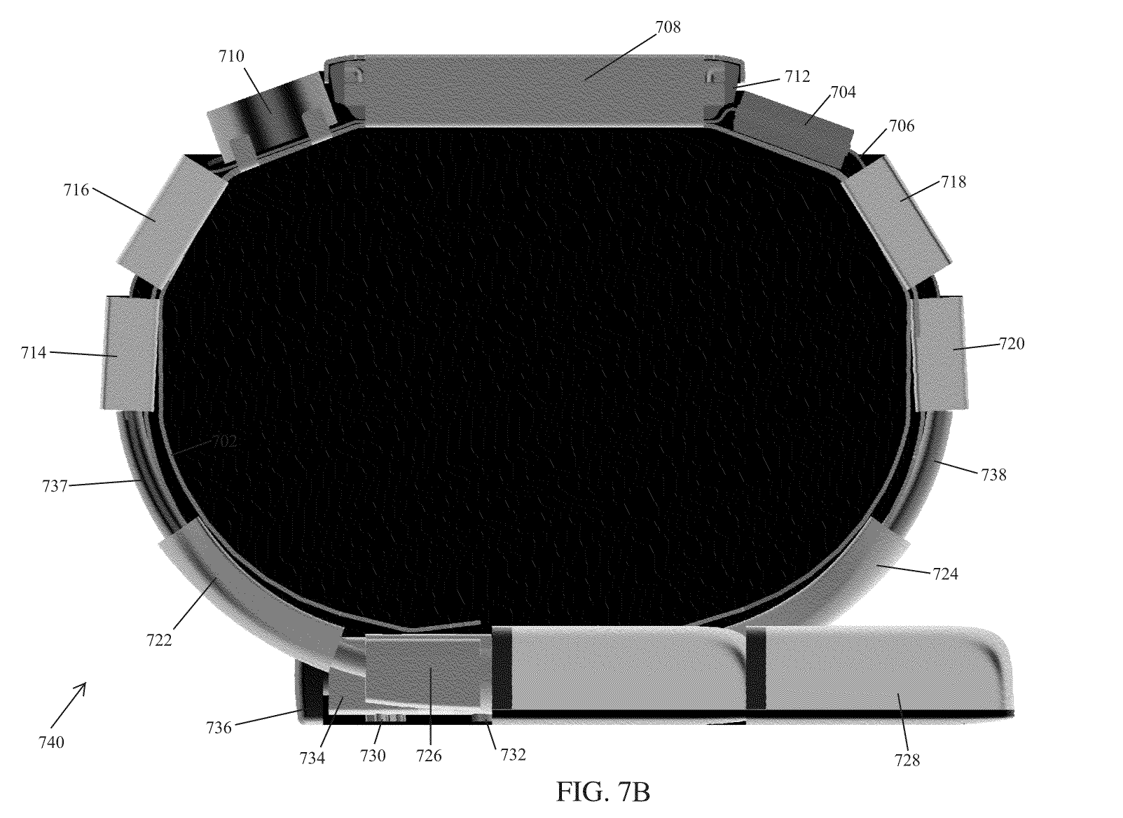

FIG. 7A illustrates a perspective view of an exemplary data-capable strapband configured to receive overmolding. Here, band 700 includes framework 702, covering 704, flexible circuit 706, covering 708, motor 710, coverings 714-724, plug 726, accessory 728, control housing 734, control 736, and flexible circuits 737-738. In some examples, band 700 is shown with various elements (i.e., covering 704, flexible circuit 706, covering 708, motor 710, coverings 714-724, plug 726, accessory 728, control housing 734, control 736, and flexible circuits 737-738) coupled to framework 702. Coverings 708, 714-724 and control housing 734 may be configured to protect various types of elements, which may be electrical, electronic, mechanical, structural, or of another type, without limitation. For example, covering 708 may be used to protect a battery and power management module from protective material formed around band 700 during an injection molding operation. As another example, housing 704 may be used to protect a printed circuit board assembly (“PCBA”) from similar damage. Further, control housing 734 may be used to protect various types of user interfaces (e.g., switches, buttons (e.g., control 736), lights, light-emitting diodes, or other control features and functionality) from damage. In other examples, the elements shown may be varied in quantity, type, manufacturer, specification, function, structure, or other aspects in order to provide data capture, communication, analysis, usage, and other capabilities to band 700, which may be worn by a user around a wrist, arm, leg, ankle, neck or other protrusion or aperture, without restriction. Band 700, in some examples, illustrates an initial unlayered device that may be protected using the techniques for protective overmolding as described above. Alternatively, the number, type, function, configuration, ornamental appearance, or other aspects shown may be varied without limitation.

FIG. 7B illustrates a side view of an exemplary data-capable strapband. Here, band 740 includes framework 702, covering 704, flexible circuit 706, covering 708, motor 710, battery 712, coverings 714-724, plug 726, accessory 728, button/switch/LED 730-732, control housing 734, control 736, and flexible circuits 737-738 and is shown as a side view of band 700. In other examples, the number, type, function, configuration, ornamental appearance, or other aspects shown may be varied without limitation.

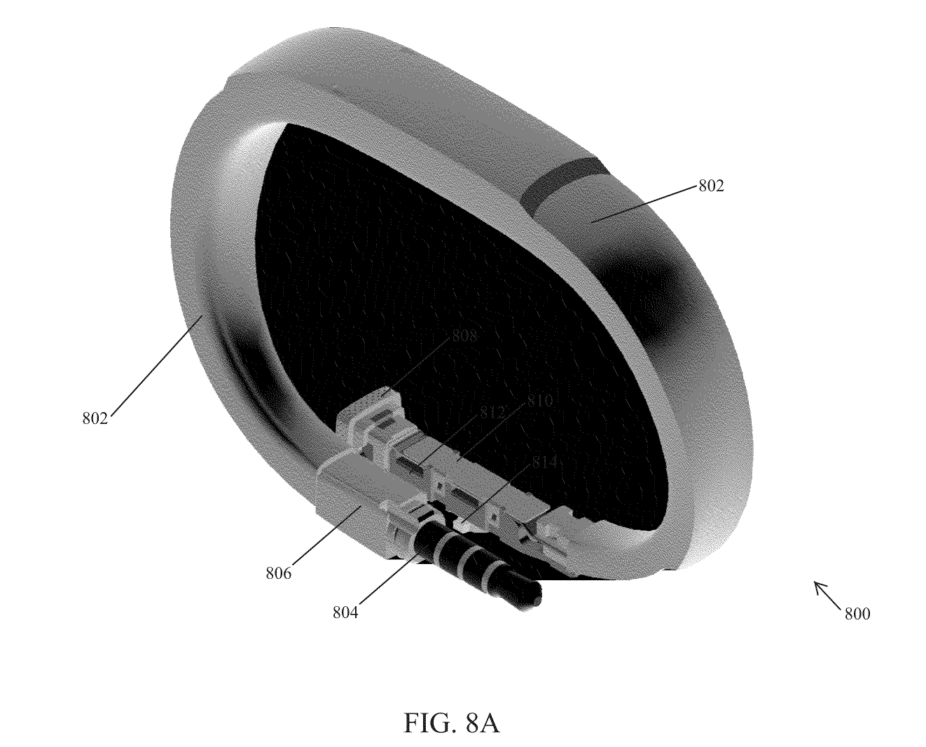

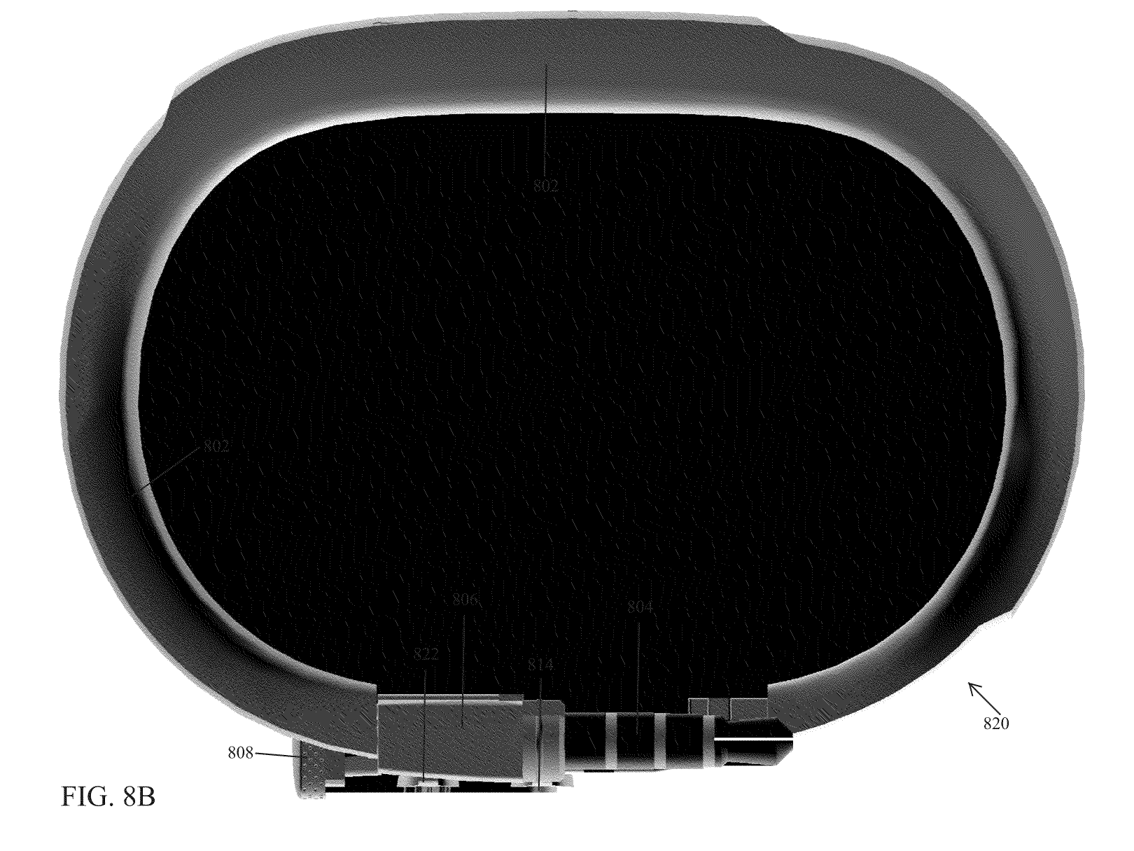

FIG. 8A illustrates a perspective of an exemplary data-capable strapband having a first molding. Here, an alternative band (i.e., band 800) includes molding 802, analog audio TRRS-type plug (hereafter “plug”) 804, plug housing 806, button 808, framework 810, control housing 812, and indicator light 814. In some examples, a first protective overmolding (i.e., molding 802) has been applied over band 700 (FIG. 7) and the above-described elements (e.g., covering 704, flexible circuit 706, covering 708, motor 710, coverings 714-724, plug 726, accessory 728, control housing 734, control 736, and flexible circuit 738) leaving some elements partially exposed (e.g., plug 804, plug housing 806, button 808, framework 810, control housing 812, and indicator light 814). However, internal PCBAs, flexible connectors, circuitry, and other sensitive elements have been protectively covered with a first or inner molding that can be configured to further protect band 800 from subsequent moldings formed over band 800 using the above-described techniques. In other examples, the type, configuration, location, shape, design, layout, or other aspects of band 800 may be varied and are not limited to those shown and described. For example, TRRS plug 804 may be removed if a wireless communication facility is instead attached to framework 810, thus having a transceiver, logic, and antenna instead being protected by molding 802. As another example, button 808 may be removed and replaced by another control mechanism (e.g., an accelerometer that provides motion data to a processor that, using firmware and/or an application, can identify and resolve different types of motion that band 800 is undergoing), thus enabling molding 802 to be extended more fully, if not completely, over band 800. In other examples, the number, type, function, configuration, ornamental appearance, or other aspects shown may be varied without limitation.

FIG. 8B illustrates a side view of an exemplary data-capable strapband. Here, band 820 includes molding 802, plug 804, plug housing 806, button 808, control housing 812, and indicator lights 814 and 822. In other examples, the number, type, function, configuration, ornamental appearance, or other aspects shown may be varied without limitation.

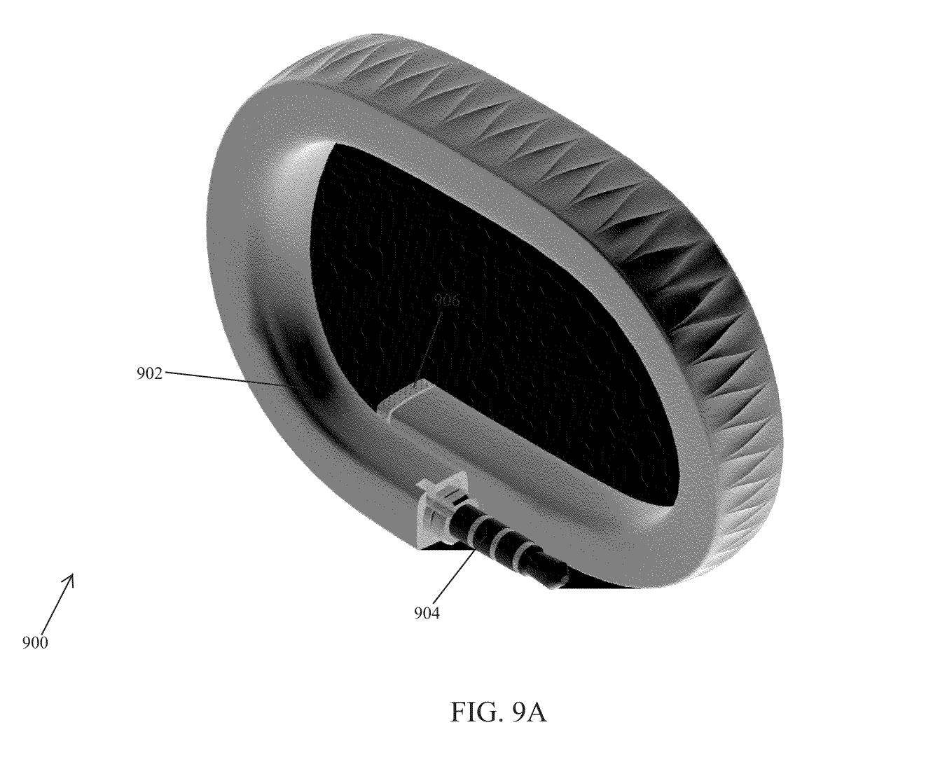

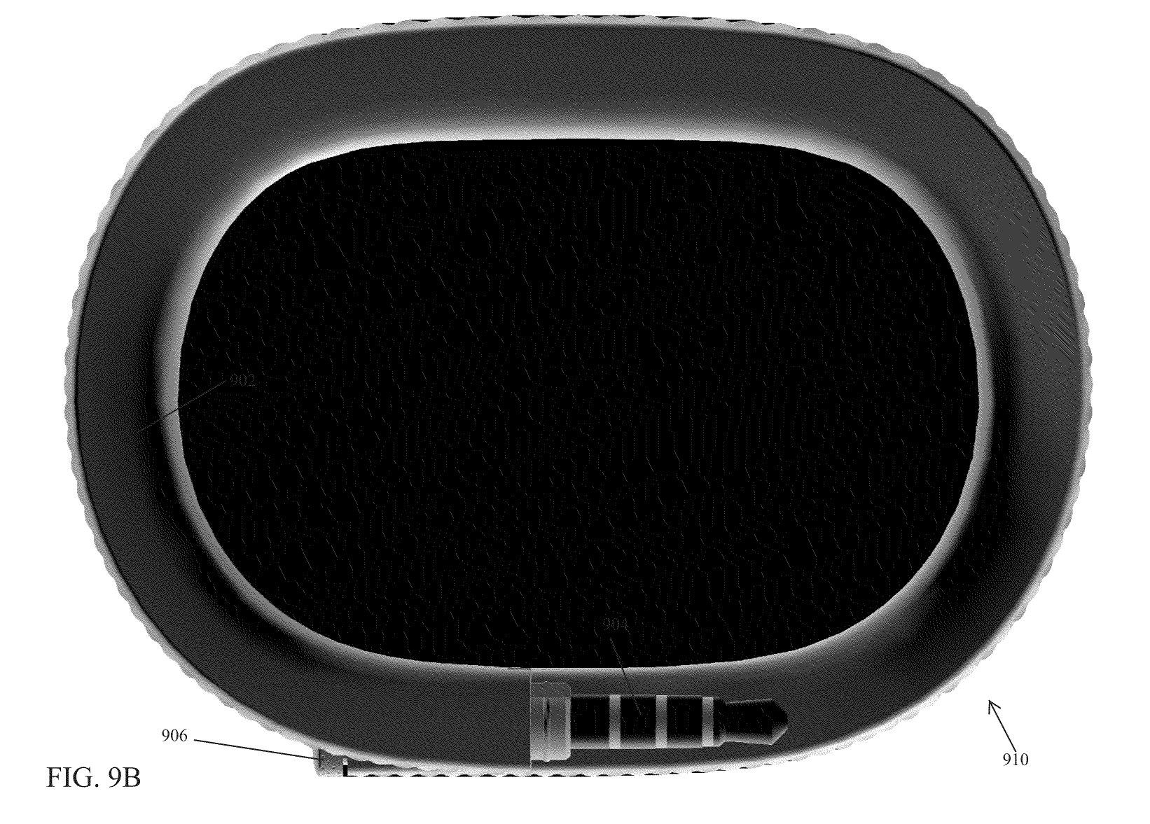

FIG. 9A illustrates a perspective view of an exemplary data-capable strapband having a second molding. Here, band 900 includes molding 902, plug 904, and button 906. As shown another overmolding or protective material has been formed by injection molding, for example, molding 902 over band 900. As another molding or covering layer, molding 902 may also be configured to receive surface designs, raised textures, or patterns, which may be used to add to the commercial appeal of band 900. In some examples, band 900 may be illustrative of a finished data-capable strapband (i.e., band 700 (FIG. 7), 800 (FIG. 8) or 900) that may be configured to provide a wide range of electrical, electronic, mechanical, structural, photonic, or other capabilities.

Here, band 900 may be configured to perform data communication with one or more other data-capable devices (e.g., other bands, computers, networked computers, clients, servers, peers, and the like) using wired or wireless features. For example, plug 900 may be used, in connection with firmware and software that allow for the transmission of audio tones to send or receive encoded data, which may be performed using a variety of encoded waveforms and protocols, without limitation. In other examples, plug 904 may be removed and instead replaced with a wireless communication facility that is protected by molding 902. If using a wireless communication facility and protocol, band 900 may communicate with other data-capable devices such as cell phones, smart phones, computers (e.g., desktop, laptop, notebook, tablet, and the like), computing networks and clouds, and other types of data-capable devices, without limitation. In still other examples, band 900 and the elements described above in connection with FIGS. 1-9, may be varied in type, configuration, function, structure, or other aspects, without limitation to any of the examples shown and described.

FIG. 9B illustrates a side view of an exemplary data-capable strapband. Here, band 910 includes molding 902, plug 904, and button 906. In other examples, the number, type, function, configuration, ornamental appearance, or other aspects shown may be varied without limitation.

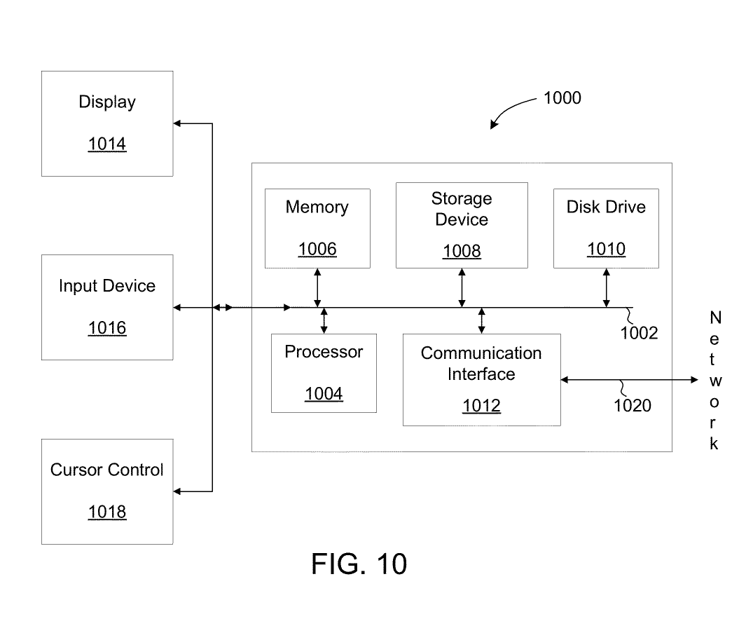

FIG. 10 illustrates an exemplary computer system suitable for use with a data-capable strapband. In some examples, computer system 1000 may be used to implement computer programs, applications, methods, processes, or other software to perform the above-described techniques. Computer system 1000 includes a bus 1002 or other communication mechanism for communicating information, which interconnects subsystems and devices, such as processor 1004, system memory 1006 (e.g., RAM), storage device 1008 (e.g., ROM), disk drive 1010 (e.g., magnetic or optical), communication interface 1012 (e.g., modem or Ethernet card), display 1014 (e.g., CRT or LCD), input device 1016 (e.g., keyboard), and cursor control 1018 (e.g., mouse or trackball).

According to some examples, computer system 1000 performs specific operations by processor 1004 executing one or more sequences of one or more instructions stored in system memory 1006. Such instructions may be read into system memory 1006 from another computer readable medium, such as static storage device 1008 or disk drive 1010. In some examples, hard-wired circuitry may be used in place of or in combination with software instructions for implementation.

The term “computer readable medium” refers to any tangible medium that participates in providing instructions to processor 1004 for execution. Such a medium may take many forms, including but not limited to, non-volatile media and volatile media. Non-volatile media includes, for example, optical or magnetic disks, such as disk drive 1010. Volatile media includes dynamic memory, such as system memory 1006.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1002 for transmitting a computer data signal.

In some examples, execution of the sequences of instructions may be performed by a single computer system 1000. According to some examples, two or more computer systems 1000 coupled by communication link 1020 (e.g., LAN, PSTN, or wireless network) may perform the sequence of instructions in coordination with one another. Computer system 1000 may transmit and receive messages, data, and instructions, including program, i.e., application code, through communication link 1020 and communication interface 1012. Received program code may be executed by processor 1004 as it is received, and/or stored in disk drive 1010, or other non-volatile storage for later execution.

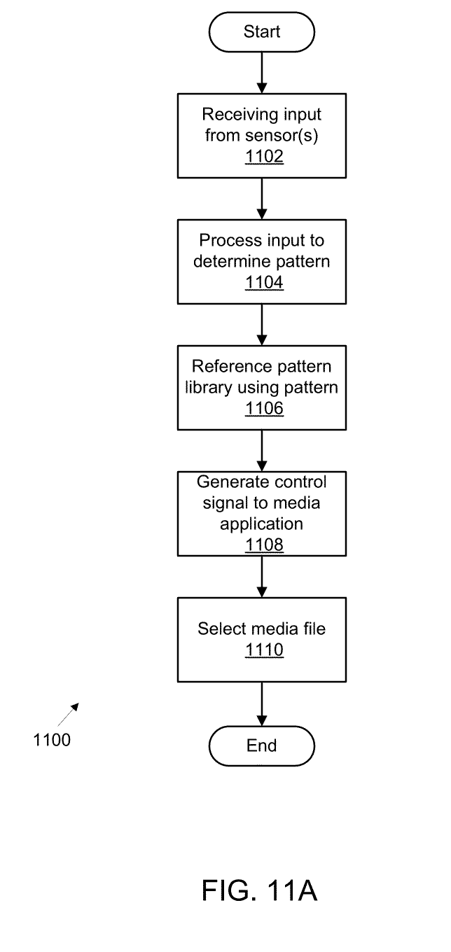

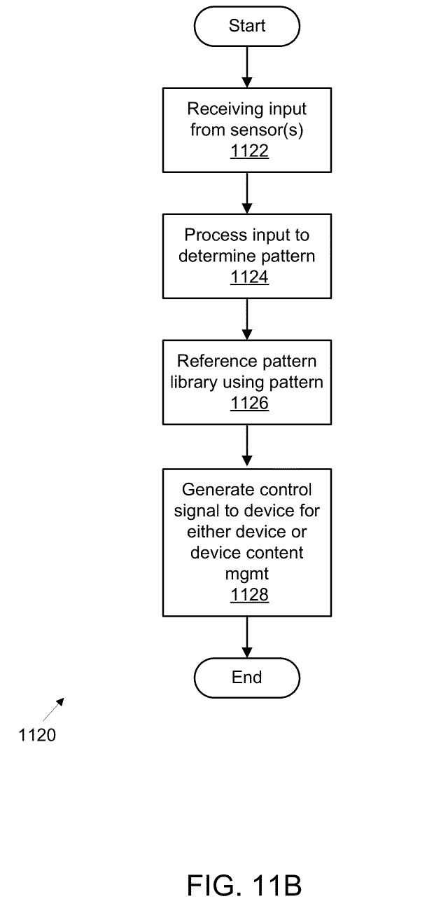

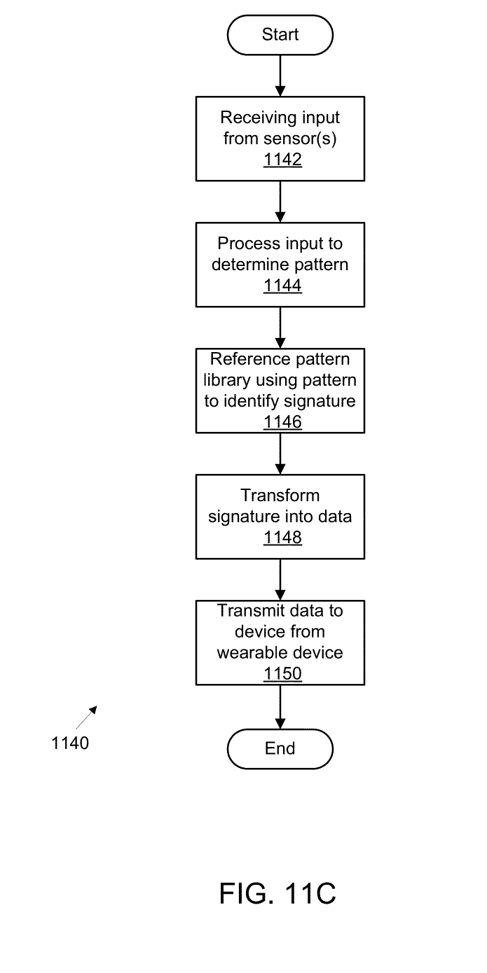

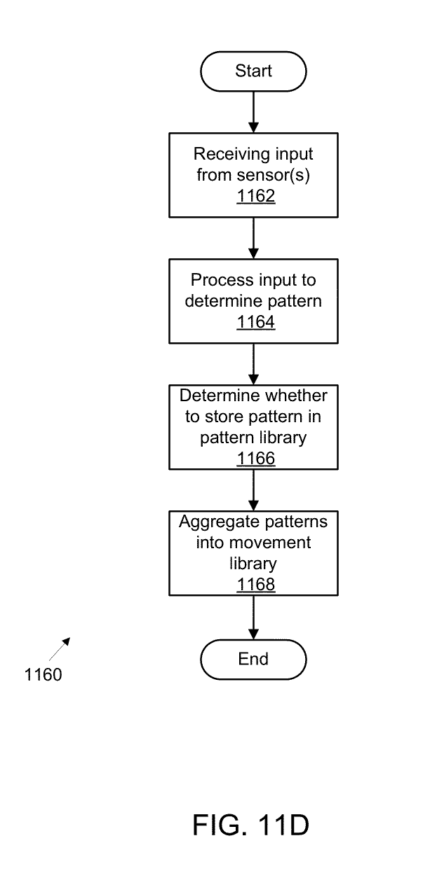

FIG. 11A illustrates an exemplary process for media device content management using sensory input. Here, process 1100 begins by receiving an input from one or more sensors that may be coupled to, integrated with, or are remote from (i.e., distributed on other devices that are in data communication with) a wearable device (1102). The received input is processed to determine a pattern (1104). Once a pattern has been determined, then a compare, lookup, or other reference operation may be performed against a pattern library (i.e., a database or other storage facility configured to store data associated with one or more patterns) (1106). As used herein, “pattern library” may be used to store patterns associated with movements, motion, moods, states, activities, events, or any other grouping of data associated with a pattern as determined by evaluating input from one or more sensors coupled to a wearable device (e.g., band 104 (FIG. 1), and others). If a given pattern is found in a pattern library, a control signal relating to the underlying activity or state may be generated and sent by a wearable device to a media application (e.g., an application that may be implemented using hardware, software, circuitry, or a combination thereof) that is configured to present media content (1108). Based on the control signal, a media file may be selected and presented (1110). For example, a given pattern may be recognized by band 612 (FIG. 6A) as a shaking motion that is associated with playing a given list of music files (e.g., playlist). When the pattern is recognized and based on input provided by a user, band 612 may be configured to send a control signal to skip to the next music file (e.g., song) in the playlist. As described in detail above in connection with FIG. 6A, any type of media file, content, or format may be used and is not limited to those described. Further, process 1100 and the above-described elements may be varied in order, function, detail, or other aspects, without limitation to examples provided.

FIG. 11B illustrates an exemplary process for device control using sensory input. Here, process 1120 begins by receiving an input from one or more sensors, which may be coupled to or in data communication with a wearable device (1122). Once received, the input is processed to determine a pattern (1124). Using the determined pattern, an operation is performed to reference a pattern library to determine whether a pre-defined or pre-existing control signal is identified (1126). If a control signal is found that correlates to the determined pattern, then wearable device 612 (FIG. 6A) (e.g., data-capable strapband, or the like) may generate the identified control signal and send it to a given destination (e.g., another device or system in data communication with wearable device 612). If, upon referencing a pattern library, a pre-defined or pre-existing control signal is not found, then another control signal may be generated and sent by wearable device 612. Regardless, after determining a control signal to send using input from one or more sensors, wearable device 612 generates the control signal for transmission to a device to either provide a device or device content control or management function (1128). In other examples, process 1120 and the above-described elements may be varied in order, function, detail, or other aspects, without limitation to examples provided.

FIG. 11C illustrates an exemplary process for wearable device data security. Here, process 1140 begins by receiving an input from one or more sensors, which may be coupled to or in data communication with a wearable device (1142). Once received, the input is processed to determine a pattern (1144). Using the determined pattern, an operation is performed to reference a pattern library to determine whether the pattern indicates a given signature that, for authentication purposes, may be used to perform or engage in a secure transaction (e.g., transferring funds or monies, sending or receiving sensitive personal information (e.g., social security numbers, account information, addresses, spouse/partner/children information, and the like)) (1146). Once identified, the signature may be transformed using various techniques (e.g., hash/hashing algorithms (e.g., MDA, SHA-1, and others, without limitation), checksum, encryption, encoding/decoding, and others, without limitation) into data formatted for transmission from wearable device 612 (FIG. 6A) to another device and/or application (1148). After transforming the signature into data, the data is transmitted from wearable device 612 to another device in data communication with the former (1150). In other examples, the data may be transmitted to other destinations, including intermediate networking routing equipment, servers, databases, data storage facilities, services, web services, and any other type of system or apparatus that is configured to authenticate the signature (i.e., transmitted data), without limitation. In still other examples, process 1140 and the above-described elements may be varied in order, function, detail, or other aspects, without limitation to examples provided.

FIG. 11D illustrates an exemplary process for movement languages in wearable devices. Here, process 1160 begins by receiving an input from one or more sensors, which may be coupled to or in data communication with a wearable device (1162). Once received, the input is processed to determine a pattern (1164). An inquiry may be performed to determine whether the pattern has been previously stored and, if not, it is stored as a new record in a database to indicate that a pattern is associated with a given set of movements, motions, activities, moods, states, or the like. If the determined pattern does have a previously stored pattern associated with the same or substantially similar set of sensory inputs (i.e., input received from one or more sensors), then the new pattern may be discarded or used update the pre-defined or pre-existing pattern. In other examples, patterns that conflict with those previously stored may be evaluated differently to determine whether to store a given pattern in a pattern library. After determining whether to store the pattern in a pattern library (i.e., in some examples, more than one pattern library may be stored on wearable device 612 or a remote database that is used by and in data communication with wearable device 612), the patterns may be aggregated in movement library to develop a “movement language” (i.e., a collection of patterns that may be used to interpret activities, states, or other user interactions with wearable device 612 in order to perform various functions, without limitation (612)). In other examples, process 1160 and the above-described elements may be varied in order, function, detail, or other aspects, without limitation to examples provided.

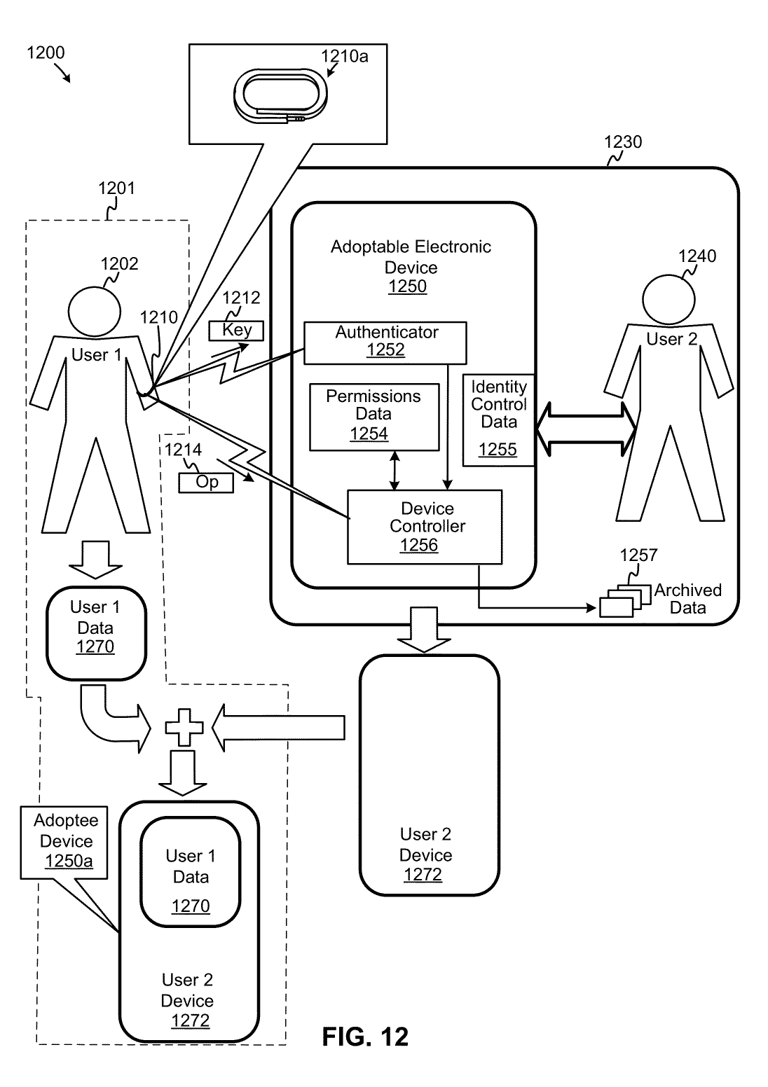

FIG. 12 is a diagram depicting an adoptable electronic device configured to facilitate adoptive access to one or more portions of the electronic device, according to some embodiments. Diagram 1200 depicts an adoptable electronic device 1250 associated with (e.g., owned by) a first entity, such as user (“2”) 1240. Adoptable electronic device 1250 is configured to provide access (e.g., secure access) to a second entity, such as user (“1”) 1242, so that adoptable electronic device 1250 can operate as an adoptee device 1250a. As shown, user (“1”) data 1270 can be combined with a user device 1272, such as a mobile phone, to form adoptee device 1250a. Generally, adoptable electronic device 1250 has a sphere of control 1230 that typically can be limited (e.g., in access, functionality, etc.) to user 1240, who has dominion over adoptable electronic device 1250. User 1202, however, can access portions of adoptable electronic device 1250 as a lendee in a lendee mode of access. In this mode, adoptee device 1250a and data 1270 are accessible to user 1202 (e.g., in some examples, data 1270 is only accessible to user 1202). Examples of adoptable electronic device 1250 include mobile phones (e.g., computing and/or communication devices, such as smart phones, tablets, etc.), media devices (e.g., audio and/or video players), wearable computing devices (e.g., computing-enhanced eyewear), and the like.

In various embodiments, adoptable electronic device 1250 can be configured to grant access to its one or more structures and/or functions, and, thereby, can operate as adoptee device 1250a. In particular, adoptee device 1250a can access data associated with a user 1202, such as user (“1”) data 1270, which, in turn, cooperates with portions of an electronic device, such as user (“2”) device 1272. Therefore, device 1272 can be perceived as being that of user 1202 while being principally controlled and/or owned by user 1240. To illustrate, consider that adoptable electronic device 1250 is a mobile phone (or computing device) associated with, or owned by, user 1240. Further, mobile phone 1250 is configured to provide access so that user 1202 can operate adoptable electronic device 1250 as if it were a mobile phone of user 1202. Thus, the mobile phone of user 1240 can be “adopted” by user 1202 such that the structures and/or functionalities of a mobile device, which is owned by one person, are accessible to another person. As such, a parent can provide a child with access to the parent's phone. For example, consider that a parent completes a telephone call using adoptable electronic device 1250 and sets adoptable electronic device 1250 phone down. The child can pick up mobile phone 1250, which configures its structures and/or functions to operate as if the phone was the child's.

Adoptable electronic device 1250 is shown to include an authenticator 1252, permissions data 1254, identity control data 1255, and a device controller 1256. Authenticator 1252 is configured to authenticate whether a request to access adoptable electronic device 1250 originates from an authorized adoptee user. Permissions data 1254, which can be disposed in a memory (not shown), are configured to permit one or more levels of access to one or more functionalities and/or structures of adoptable electronic device 1250 by others than user 1240. For example, a mobile phone and/or computing device can include logic configured to selectably provide voice communications (e.g., telephone calls), textual communications (e.g., emails, SMS texts, etc.), browser interface capabilities, and the like. User 1240 can establish a list of permissions stored as permissions data 1254 that either permits or denies access to any specific structure or function of an adopted phone.

Identity control data 1255, which can be disposed in the same or different memory as permissions data 1254, are configured to identify an entity, such as user 1240, that has ownership, possession, control, or the like, over adoptable electronic device 1250. For example, if adoptable electronic device 1250 is a mobile phone, identity control data 1255 can specify a unique identifier that specifically identifies, at least in some cases, one or more of user 1240, adoptable electronic device 1250, and/or a data subscription for which a services provider provides cellular voice services, data communication services, or other like services using adoptable electronic device 1250. Device controller 1256 is configured to control the various operations of adoptable electronic device 1250, and, for example, can be composed of proprietary hardware and/or software, as well as specialized hardware and/or software configured to effectuate the various implementations described herein. Device controller 1256 can also be configured to generate archived data 1257, which include data representing operations (as well as any other data related to a lendee mode of access). For example, if adoptable electronic device 1250 is a mobile phone, archived data 1257 can include a number of data packets transmitted or communicated, a number of minutes during which cellular telephone data is communicated, and the like during the lendee mode of operation. A lender of device 1250 then can seek reimbursement.

According to some embodiments, adoption of electronic device 1250 by user 1202 can be automatic. Thus, access to, and/or operability of, adoptable electronic device 1250 can automatically transfer from user 1240 to user 1202. In some examples, adoptable electronic device 1250 is configured to transition between a lender mode of access (e.g., a mode of access and/or operability associated with user 1240 as a “lender” of such a device) and a lendee mode of access (e.g., a mode of access and/or operability associated with user 1202 as a “lendee” of such a device). In a lender mode of access, user 1240 can use adoptable electronic device 1250 as configured with data associated with user 1240, whereas in a lendee mode of access, user 1202 can user adoptable electronic device 1250 as adoptee device 1250a, which is configured with data 1270 to provide access (e.g., secured access) and/or operability with which user 1202 is familiar.

A wearable device 1210 can facilitate adoption (e.g., automatic adoption) of adoptable electronic device 1250, according to some embodiments. Automatic device adoption can implement any type of wireless communication link to exchange data for facilitating automatic adoption. For example, data representing key 1212 (e.g., key data) and/or data representing operational information (e.g., “Op,” or operation data) 1214 can be transmitted to adoptable electronic device 1250. Key data 1212 includes data configured to provide secure access to adoptable electronic device 1250, at various levels of a functionality of device 1250 (or portions thereof). Operation data 1214 includes data configured to facilitate operability of one or more portions of device 1250. Operation data 1214 can configure device 1250 to operate as if device 1250 is owned or otherwise controlled by user 1202.

In view of the foregoing, the functions and/or structures of adoptable electronic device 1250 and/or its components, such as authenticator 1252 and device controller 1256, can be configured to facilitate automatic adoption of an electronic device (or one or more portions thereof) by an authorized user. Thus, user 1202 can, at least in some examples, perform an activity, other than entering a password manually, that initiates automatic adoption of the electronic device to form an adoptee device, which can be used by user to 1202 as a lendee (e.g., one to whom a device is loaned). Further, automatic adoption of an electronic device, according to various embodiments, can be initiated by an activity performed by user who is wearing or otherwise carrying a wearable device 1210. An example of such an activity includes moving wearable device 1210 in close proximity to adoptable electronic device 1250 (including picking up or physically contacting the electronic device). According to various examples, operational data can be transmitted from wearable device 1210, or can be received into adoptable electronic device 1250 from the wearable device or any other source of operational data. Such operational data can cause adoptable electronic device 1250 to emulate operation of device (e.g., a similar device) that is used by user 1202 or is otherwise configured to operate in accordance with the preferences of user 1202.

To illustrate, consider that adoptable electronic device 1250 is a mobile phone owned or otherwise controlled by a parent. Consider that a child may be given access to the parent's phone, such that when the child wearing a wearable device 1210 performs an action (e.g., moves in proximity to adoptable electronic device 1250), the parent's phone will transform or otherwise be configured to appear as the child's phone. The child need not have access to the parent's data (or full access to available phone functions, including SMS texting, application (“app”) purchasing, emails, games, etc.) during the lendee mode of operation. While the child may have access to its contact information, such as the child's friends, the child need not have access to the parent's contact information. According to some embodiments, wearable computing device 1210 can be configured to authenticate whether a wearer or carrier of wearable device 1210 is user 1202, rather than permitting access by an unauthorized person to adoptable electronic device 1250. That is, wearable computing device 1210 can determine, at least in some cases, when an unauthorized person is carrying and/or wearing device 1210. In such cases, wearable computing device 1210 can disable transmission of key data 1212 as well as other data. In some examples, data associated with user 1240 is not accessible by user 1202 during a lender mode of operation, and/or user data 1270 associated with user 1202 is not accessible by user 1240 during the lendee mode of operation. As noted earlier, user 1240 and/or adoptable electronic device 1250 can use archived data 1257 to seek, for example, reimbursement for costs associated the lendee mode of operation.

In at least some embodiments, wearable device 1210 can be any computing device that is either configured to be worn or carried by a user, and is further configured to perform one or more of the functions described herein. For example, wearable device 1210 can be implemented as wearable computing device 1210a. An example of a suitable wearable device 1210a, or a variant thereof, is described in U.S. patent application Ser. No. 13/454,040, which was filed on Apr. 23, 2012, which is incorporated herein by reference. An example of wearable device 1210a is UP™ manufactured by AliphCom of San Francisco, Calif. Wearable device 1210a can include a transceiver configured to transmit and/or receive data via a communications link, such as a wireless communications link. Examples of such communications links include near field communications (“NFC”) links, Bluetooth® links, WiFi (e.g., Wi-Fi Direct™), audio/audible data signals, and other like communication links or protocols. The above-described communication links can be used to transmit key data 1212 and/or operation data 1214, as well as any other data. Key data 1212 can specify one or more conditions in which a wearer of wearable device 1210 has lendee access to operations of an electronic device. For instance, key data 1212 can include login and/or password data that is received by authenticator 1252, which, in turn, is configured to provide access to the services and/or functions of adoptable electronic device 1250. Such security data can be encrypted prior to transmission from wearable computing device 1210 and can be decrypted by authenticator 1252. According to some examples, key data 1212 also can include authentication user data that indicates whether the person wearing a wearable device 1210 is actually user 1202, who is authorized to gain lendee access to adoptable electronic device 1250 (or whether the person wearing device 1210 a different person than who is authorized). Thus, authenticator 1252 can be configured to analyze the authentication user data to determine whether to deny access to the person wearing a wearable device 1210 if the authentication user data fails to reach a threshold of certainty that the identity of the wearer is known or otherwise authorized to access adoptable electronic device 1250. Operation data 1214 can include functional data and/or executable instructions, as well as application data. For example, operation data 1214 can include data representing contact data to facilitate telephonic communications, data representing email address data configured to facilitate text-based communications, and/or playlist data configured to facilitate playback of audio by adoptable electronic device 1250 as a media device. Permissions data 1254 includes data that describes whether a user 1202 has access to one or more portions of adoptable electronic device 1250. For example, permissions data 1254 can specify the degree to which user 1202 has access to various portions electronic device 1250. In cases in which adoptable electronic device 1250 is a mobile phone, permissions data 1254 can specify whether a user 1202 can gain access in a lendee mode of operation to telephonic functions, email functions, SMS text functions, and any other like function.

To illustrate operation of adoptable electronic device 1250, consider the following example. A key, such as included within key data 1212, can be received into adoptable electronic device 1250, where key data 1212 is configured to provide a lendee mode of access to one or more portions of adoptable electronic device 1250. Further, adoptable electronic device 1250 can include identity control data 1255 specifying an entity having a lender mode of access to the electronic device. Examples of an entity include a person, a group of people, or any computing device. Identity control data 1255 can be disposed in memory (not shown) and can identify or associate the identity of the user 1240 with adoptable electronic device 1250. Identity control data 1255 can be implemented in hardware and/or software, examples of which include subscriber identification module (“SIM”) cards, and related information, integrated circuit card identifiers (“ICCID”), MAC addresses, IP addresses, and any other identifiers that can link or otherwise provide data access between a service provider (e.g., a telephonic cellular carrier, a network or Internet service provider, or the like) and adoptable electronic device 1250. Identity control data 1255 can provide user 1240 control and ownership over electronic device 1250. Such control and ownership can provide or facilitate the lending (e.g., temporary lending) of one or more functions of electronic device 1250 to user 1202.

Authenticator 1252 can authenticate the key to provide the lendee mode of access to one or more portions of the electronic device, as defined by permissions data 1254. Adoptable electronic device 1250 can import operation data 1214 into, for example, a memory to form imported operation data. A portion of hardware and/or software of electronic device 1250 can be configured to provide a telephonic function that controls voice communications. In some cases, data representing a user input is received via an interface (not shown) of adoptable electronic device 1250. An example of the interface includes a touch-sensitive (“capacitive”) screen. The user input can be configured to cause initiation of the function of the portion of the electronic device. Device controller 1256 can be configured to cause electronic device 1250 to perform functions based on the imported operation data in the lendee mode of access. In some examples, the key facilitates automatic adoption of the electronic device for use by a first entity (e.g., user 1202) in the lendee mode of operation independent of the identity control data limiting the lender mode of access to a second entity (e.g., user 1240). In some embodiments, authenticator 1252 can be configured to detect wearable device 1210 from which the above-described data originates. For example, authenticator 1252 can cause the authentication process to begin when, for example, wireless signals from wearable device 1210 are detected. In at least one embodiment, such wireless signals can be based on NFC protocols.

In some embodiments, adoptable electronic device 1250, such as a mobile phone device or computing device (or a device in which it is disposed) can be in communication (e.g., wired or wirelessly) with a wearable device 1210. In some cases, an adoptable mobile device 1250 or wearable computing device 1210 can be configured to communicate with any networked computing device (not shown) to at least access some of the structures and/or functions of any of the features described herein. As depicted in FIG. 12 and subsequent figures (or any figures herein), the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 12 (or any figure) can represent one or more algorithms. Or, at least one of the elements can represent a portion of logic including a portion of hardware configured to provide constituent structures and/or functionalities.

For example, adoptable electronic device 1250 and any of its one or more components, such as authenticator 1252 and device controller 1256, can be implemented in one or more computing devices (i.e., any video-producing device, such as mobile phone, a wearable computing device, such as UP®) or a variant thereof), or any other mobile computing device, such as a wearable device or mobile phone (whether worn or carried), that includes one or more processors configured to execute one or more algorithms in memory. Thus, at least some of the elements in FIG. 12 (or any figure) can represent one or more algorithms. Or, at least one of the elements can represent a portion of logic including a portion of hardware configured to provide constituent structures and/or functionalities. These can be varied and are not limited to the examples or descriptions provided. According to some examples, wearable device 1210 and any of its one or more components can be implemented in one or more computing devices, such as a wearable device or mobile phone (whether worn or carried), that include one or more processors configured to execute one or more algorithms in memory.

As hardware and/or firmware, the above-described structures and techniques (as well as other structures and techniques described herein) can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, adoptable electronic device 1250 and any of its one or more components, such as authenticator 1252 and device controller 1256, can be implemented in one or more circuits. Thus, at least one of the elements in FIG. 12 (or any figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

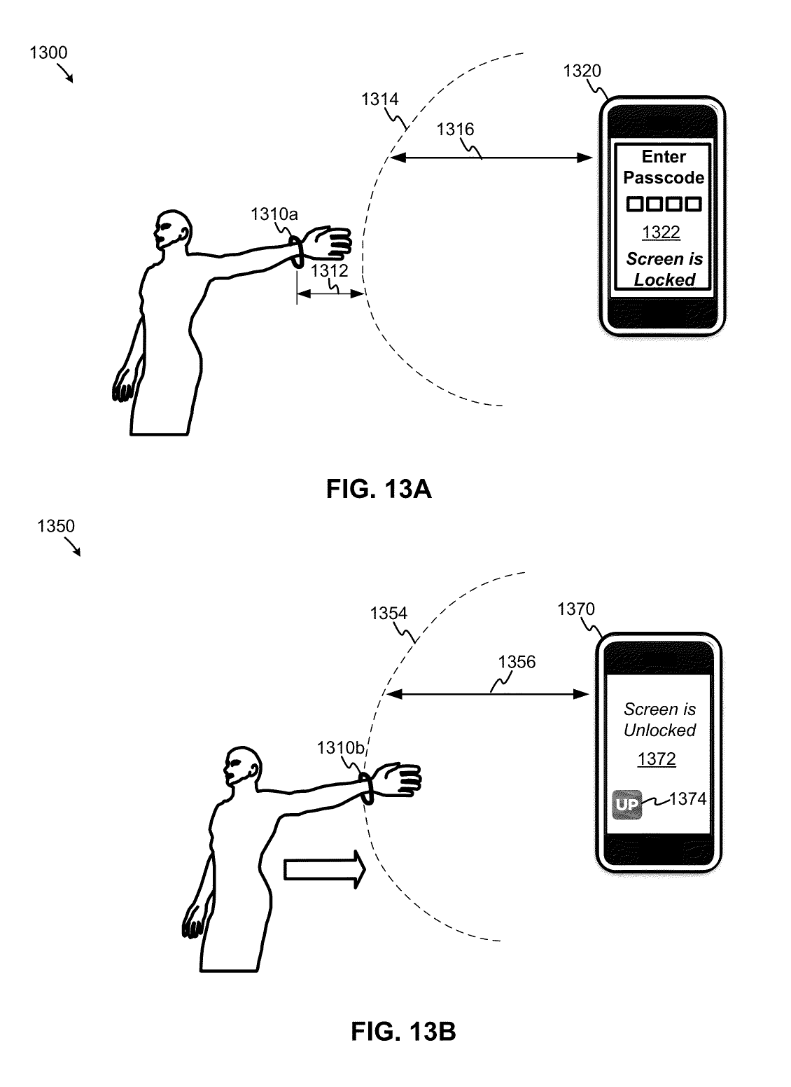

FIGS. 13A and 13B depict automatic device adoption based on proximity, according to some embodiments. FIGS. 13A and 13B illustrate that a user can perform an activity, other than entering a password manually or the like, that causes automatic adoption of the electronic device based on a spatial relationship between adoptable electronic device, such as device 1320 and wearable device 1310a. In the example shown in diagram 1300 of FIG. 13A, a user and wearable device 1310a can change in proximity or distance 1316 relative to electronic device 1320. In this case, wearable device 1310a is at a distance 1312 from a proximity boundary 1314, which is at a distance 1316 from adoptable electronic device 1320. As wearable device 1310a is beyond proximity boundary 1314, adoptable electronic device 1320 may not detect the presence of wearable device 1310a. Thus, adoptable electronic device 1320 remains secure with no access available to the user wearing device 1310a. As shown, a touch-sensitive screen 1322 is locked.

However, when the user moves toward electronic device 1370, as shown in diagram 1350 of FIG. 13B, wearable device 1310b passes through the proximity boundary 1354. For example, the electronic device 1370 can determine that wearable device 1310b is proximate to electronic device 1370, thereby enabling authentication of a key. Wearable device 1310b is proximate to electronic device 1370 if wearable device electronic device 1370 is with a range of distances 1356 from electronic device 1370. As shown, wearable device 1310b is at less than distance 1356 from adoptable electronic device 1370. In this case, adoptable electronic device 1370 can detect the presence of wearable computing device 1310b. Further, adoptable electronic device 1370 can retrieve a key from wearable computing device 1310b for purposes of authenticating the user in unlocking the screen. As shown, the screen is unlocked, thereby providing access for the user as a lendee of the adoptee electronic device. As shown, screen 1372 is unlocked so that the user can have access to one or more functions (such as an application 1374). According to some examples, near-field communication and related wireless signals can provide for detection wearable device 1310b, authentication of the identity of the user, and automatic adoption of the electronic device. Note that the various examples described herein are not limited to near field communications, but can use any type of wireless signals and processes to retrieve key data, including establishing a short-range communication link over which to convey the key. Note too that distance 1356 can be any distance including approximately zero units of distance. For example, automatic adoption processes can be initiated, as described herein, when a user contacts or picks up electronic device 1370, or places device 1310b in physical contact with device 1370.

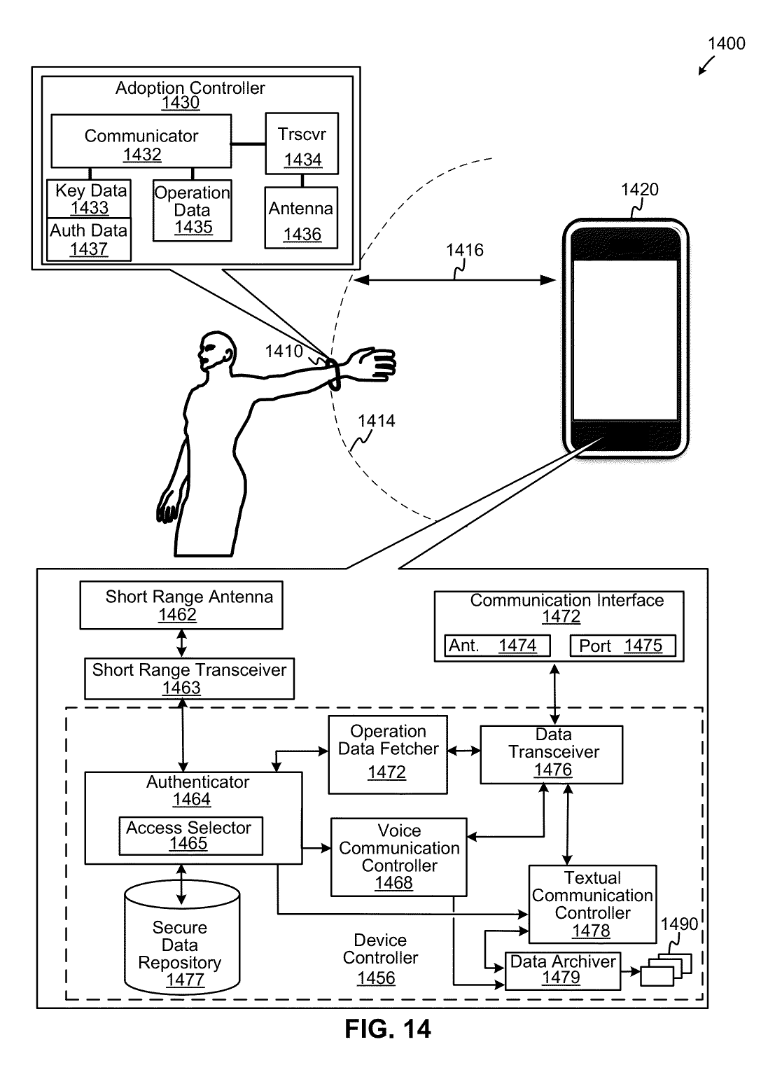

FIG. 14 depicts an adoption controller and a device controller, according to some examples. A wearable device 1410 in diagram 1400 is depicted as including an antenna 1436 (e.g., a Bluetooth antenna, an NFC antenna, or any RF antenna), a transceiver (“Trscvr”) 1434 configured to transmit data via a communication link (e.g., short-range communication link) over at least a distance 1416 between a proximity boundary 1414 and electronic device 1420. Adoption controller 1430 further includes a communicator controller 1432 configured to receive data (e.g., from memory), such as key data 1433, authentication data 1437, and operation data 1435. Adoption controller 1430 can be configured to detect a short-range communication link, and further configured to transmit key data 1433 and/or operation data 1435 to electronic device 1420 to transition electronic device 1420 from a lender mode of operation to a lendee mode of operation to enable a wearer to use electronic device 1420. Key data 1433 can be configured to specify one or more conditions in which a wearer of wearable device 1410 has lendee access to operations of an electronic device. For example, key data 1433 can be configured to facilitate vary the terms of automatic adoption of electronic device 1420 based on the time of day, the geographic location of device 1420, the identity of the wearer, the purpose in which device 1420 is being used, etc. Operation data 1435 is configured to specify one or more portions of data that are configured to that are configured to facilitate at least a subset of the operations of the electronic device 1420. For example, operation data 1435 can include contact data configured to facilitate telephonic communications, email address data configured to facilitate text-based communications, and/or playlist data configured to facilitate playback of audio by electronic device 1420. According to some embodiments, authentication data 1437 can be configured to specify whether a wearer of wearable device 1410 is authorized to use wearable device 1410 in a manner that causes adoption of the electronic device 1420. Examples of authentication data 1437 include “lifescore” data generated by one or more physiological characteristics of wearer that can be compared to a set of physiological characteristics (e.g., a gait, a heart rate, etc.) of an authorized user to confirm whether the wearer is an authorized user. Examples of such data are disclosed in U.S. patent application Ser. No. 13/831,139, filed on Mar. 14, 2013 and entitled BIOMETRIC IDENTIFICATION METHOD AND APPARATUS TO AUTHENTICATE IDENTITY OF A USER OF A WEARABLE DEVICE THAT INCLUDES SENSORS, and in U.S. patent application Ser. No. 13/802,283, filed on Mar. 13, 2013 and entitled VALIDATION OF BIOMETRIC IDENTIFICATION USED TO AUTHENTICATE IDENTITY OF A USER OF WEARABLE SENSORS, both of which are incorporated by reference.

As shown in this example, electronic device 1420, which is adoptable, can be configured to include a short-range antenna 1462 and a short-range transceiver 1463, but is not limited in each implementation to being short range. Short-range transceiver 1463 can be configured to receive at least key data 1433 in the lendee mode of operation when wearable device 1410 is within a proximity boundary 1414 related to electronic device 1420. Electronic device 1420 also can include a communication interface 1472 configured to communicate to third-party entities, such as service providers, cellular phone carriers, data network providers, etc. Communication interface 1472 also can include an antenna 1474, such as a Wi-Fi antenna, and a port 1475 to provide hard-wired connections, such as an Ethernet connection or an audio data connection.

Further, electronic device 1420 can include a device controller 1456. As shown, device controller 1456 includes an authenticator 1464, an operation data fetcher 1472, a data transceiver 1476, a secure data repository 1477, a voice communication controller 1468, a textual communication controller 1478, and a data archiver 1479. Authenticator 1464 is configured to authenticate key data 1433 and provide access to electronic 1420. Access selector 1465, which can be included in authenticator 1464, can be configured to select a level of access (e.g., email access, telephonic access, etc.) to one or more portions of electronic device 1420. Operation data fetcher 1472 is coupled to data transceiver 1476, and is configured to fetch, for example, operation data 1435 from a location other than wearable device 1410. For example, operation data fetcher 1472 can access a remote server via a network to obtain key data 1433 as well as any other type of data, including operation data 1435.

Device controller 1456 can be configured to invoke or otherwise activate voice communication controller 1468, which is configured to establish a voice-based data connection as the communication link. For example, voice communication controller 1468 can include hardware and/or software that are configured to facilitate telephonic communications via, for example, a cellular data network. In this case, the operation data can include contact information containing a number of names associated with a number of phone numbers. Further, device controller 1456 can be configured to invoke or otherwise invoke a textual communication controller that is configured to establish a text-based data communication link. For example, textual communication controller 1478 can include hardware and/or software that are configured to facilitate text-based communications via, for example, a data network. In this case, operation data 1435 can include email address information and/or SMS text addressing information including a number of names associated with a number of email addresses or SMS-capable phones. Voice communication controller 1468 and textual communication controller 1478 can be configured to use data transceiver 1476 (e.g., an RF transceiver) to facilitate such communications.

Secure data repository 1477 is configured to maintain data, such as operation data 1435, secure from access from other entities including the entity or owner of electronic device 1420. Therefore, contact information for the user who has been granted lendee access to electronic device 1420, may maintain privacy over such as information as if the adopted electronic device was owned by the lendee user. Thus, access to secure data repository 1477 can be denied in the lender mode of access, and, as such, that the owner of electronic device 1420 cannot access the imported operation data. Optionally, the owner of electronic device 1420 can disable secure data repository 1477 and have access to such data. For example, a parent that wishes to lend a mobile computing device to a child may wish to have access to data in repository 1477. Data archiver 1479 is configured to generate archival data 1490 that describes activities by the lendee user, as well as costs related to using cellular services, network services, and other types of services. In some cases, archival data 1490 can be configured to cause automatic reporting of such costs from the lendee to the lender.

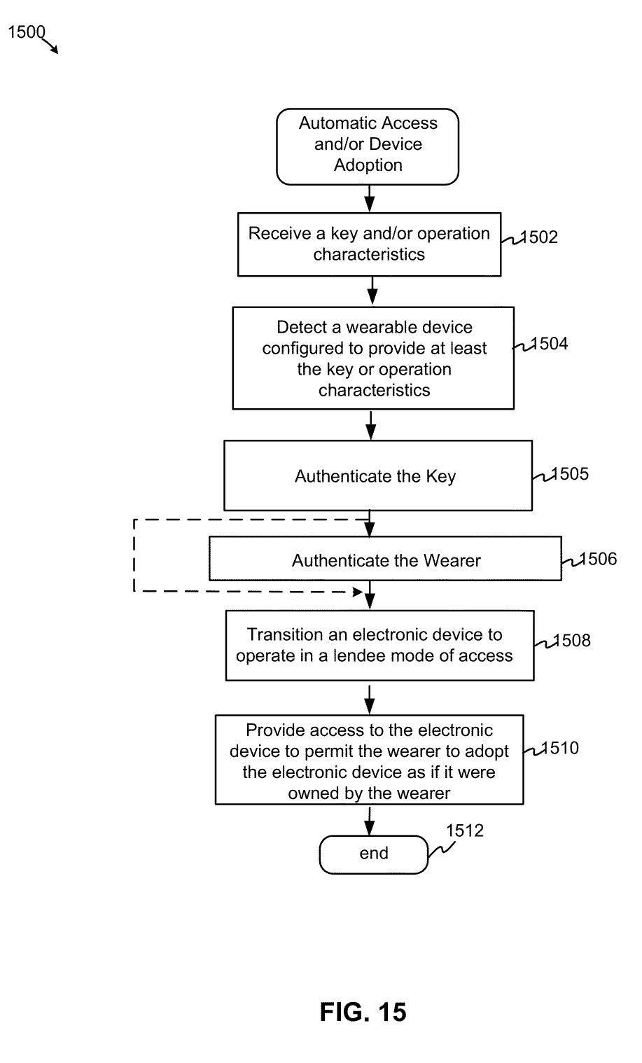

FIG. 15 depicts an example flow to provide automatic access or automatic device adoption, according to some embodiments. At 1502, key and/or operation characteristics are received. In some cases, the key and operation characteristics can be described by key and operation data, respectively. At 1504, a wearable device is detected, where the wearable device is configured to provide at least the key or operation data. At 1505, the key can be authenticated to determine whether a wearer of the wearable device is authorized to gain access to an adoptable electronic device. Optionally, at 1506, the identity of the wearer can be authenticated to determine whether the person actually wearing or carrying a wearable device is authorized to receive access to adoptable electronic device. At 1508, upon authentication of the wearer and/or wearable device, the electronic device is adopted and is transitioned from a lender mode of access to a lendee mode of access. At 1510, access is provided to the electronic device to permit the wearer to adopt the device as if that device were owned by the wearer, albeit temporary. Flow 1500 terminates at 1512.

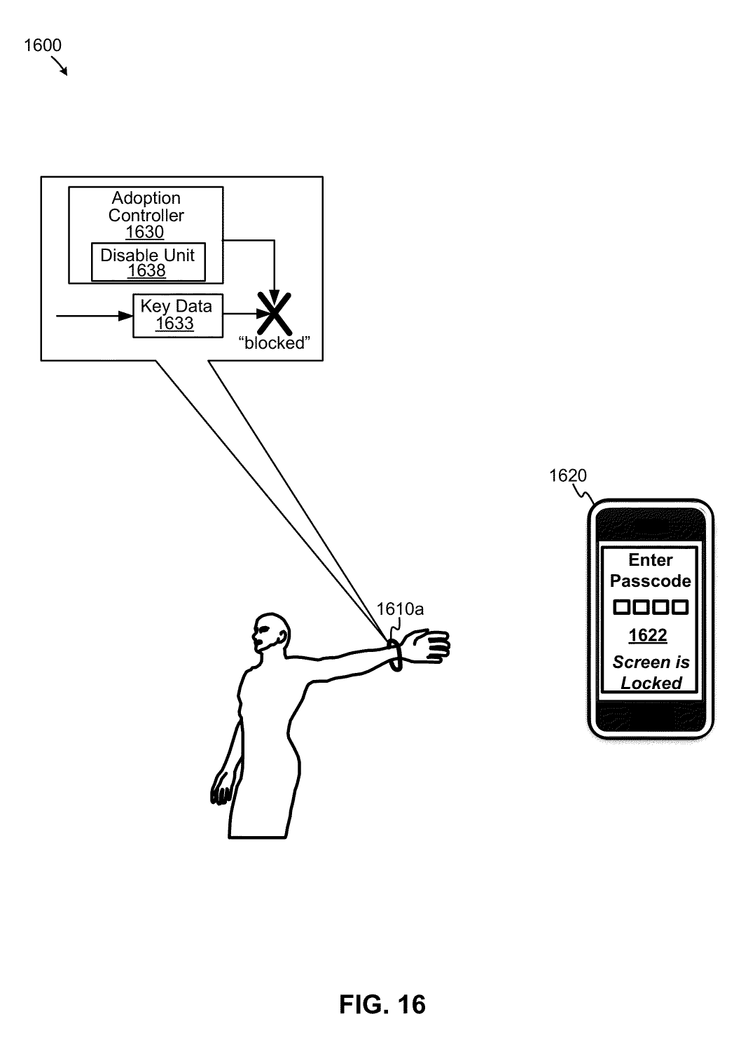

FIG. 16 depicts an adoption controller configured to block transmission of key data, according to some examples. Diagram 1600 depicts an adoption controller 1630 including a disabled unit 1638. Disable unit 1638 is configured to receive authentication data that indicates whether the wearer of wearable device 1610 is authorized to gain access to electronic device 1620. If disable unit 1638 detects data that indicates the wearer is not authorized, disable unit 1638 operates to prevent transmission of key data 1633 to electronic device 1620, which then remains in a locked state of operation. As shown, screen 1622 is locked.

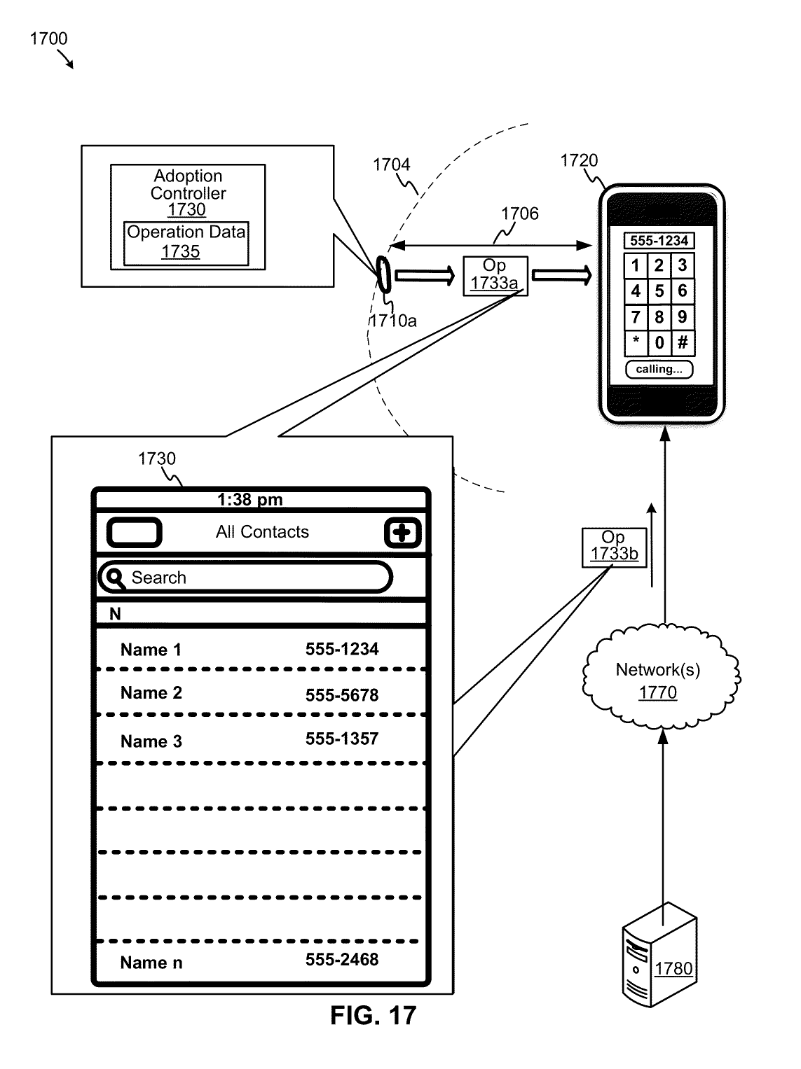

FIG. 17 depicts operation data including contact information, according to some embodiments. Diagram 1700 depicts an adoption controller 1730 including operation data 1735. In the example shown, operation data 1733a is transmitted from wearable device 1710a when the wearable device is within a proximity boundary 1704, which is at a distance 1706 from electronic device 1720. Further to diagram 1700, operation data 1733a is shown to include data arranged in data structure 1730, which includes contact information, such as names and phone numbers. In some examples, operation data 1733b can be received via network 1770 from a remote server and/or computing device 1780.

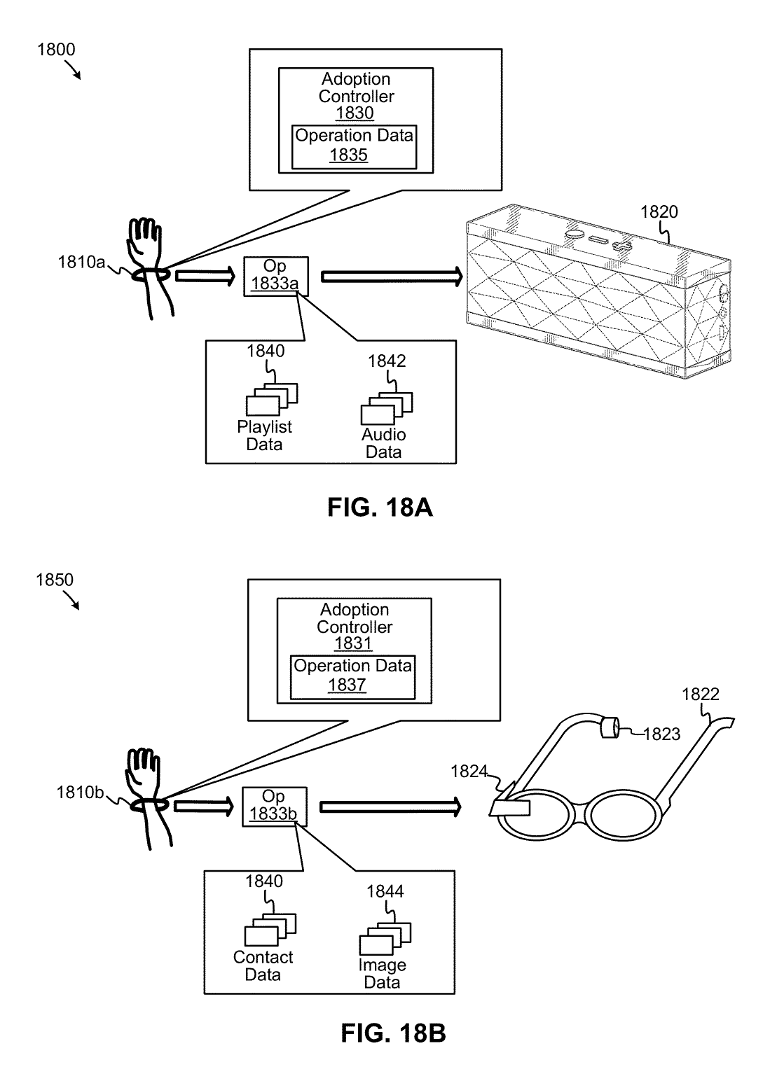

FIGS. 18A and 18B depict alternate forms of operation data, according to some examples. Diagram 1800 depicts an adoption controller 1830 including operation data 1835. In the example shown, operation data 1833a is transmitted from wearable device 1810a to electronic device 1820. Further to diagram 1800, operation data 1833a is shown to include playlist data 1840 and audio data 1842, which can include music and/or songs. In some examples, operation data 1833b can be received via a network from a remote server and/or computing device (not shown). An example of an electronic device 1820 as a media device, as well as examples of its components or elements, is disclosed in U.S. patent application Ser. No. 13/831,422, entitled “Proximity-Based Control of Media Devices,” filed on Mar. 14, 2013 with Attorney Docket No. ALI-229, which is incorporated herein by reference. In various examples, media device 1820 is not limited to presenting audio, but rather can present both visual information, including video (e.g., using a pico-projector digital video projector or the like) or other forms of imagery along with (e.g., synchronized with) audio. At least some components of media device 1820 can be implemented similarly as Jambox® products produced by AliphCom, Inc., of California.

Diagram 1850 depicts an adoption controller 1831 including operation data 1837. In the example shown, operation data 1833b is transmitted from wearable device 1810b to electronic device 1822, which in this example, is a computing-based set of eyewear that includes a visual display 1824 and one or more processors 1823. Further to diagram 1850, operation data 1833b is shown to include contact data 1840 and image data 1844, which can include image and video data. In some examples, operation data 1833b can be received via a network from a remote server and/or computing device (not shown).

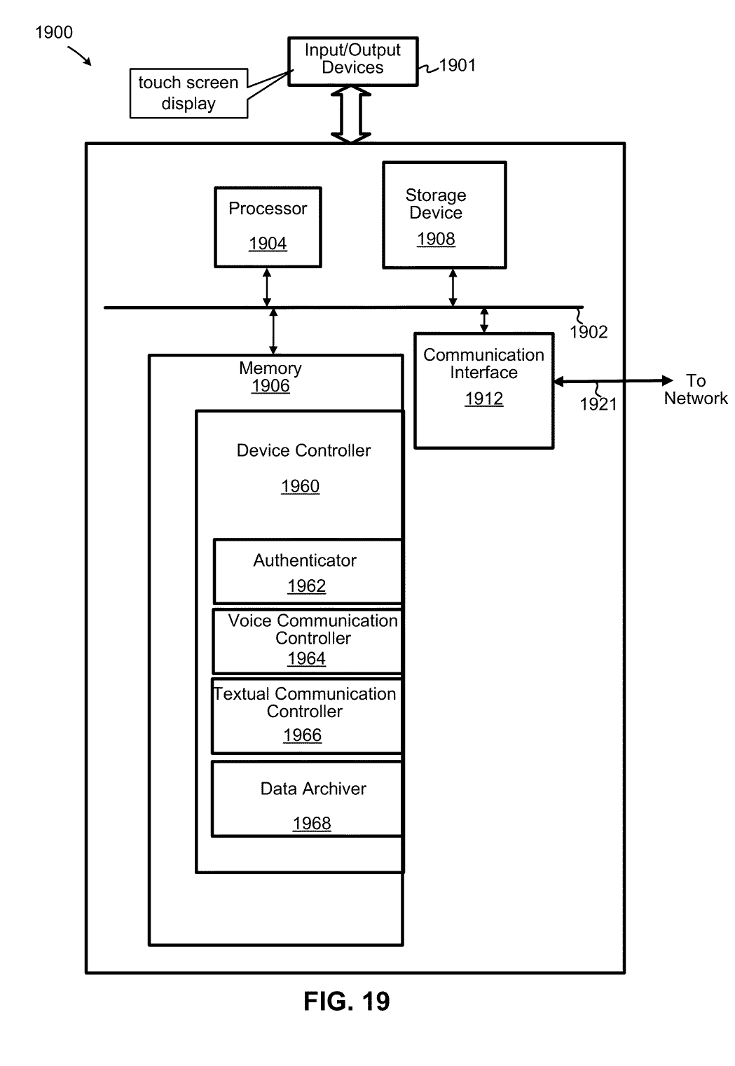

FIG. 19 illustrates an exemplary computing platform disposed in a media device, a mobile device, a wearable device, or any computing device, according to various embodiments. In some examples, computing platform 1900 may be used to implement computer programs, applications, methods, processes, algorithms, or other software to perform the above-described techniques. Computing platform 1900 includes a bus 1902 or other communication mechanism for communicating information, which interconnects subsystems and devices, such as processor 1904, system memory 1906 (e.g., RAM, etc.), storage device 1908 (e.g., ROM, etc.), a communication interface 1913 (e.g., an Ethernet or wireless controller, a Bluetooth controller or transceiver, NFC transceiver, etc.) to facilitate communications via a port on communication link 1921 to communicate, for example, with a computing device, including mobile computing and/or communication devices with processors. Processor 1904 can be implemented with one or more central processing units (“CPUs”), such as those manufactured by Intel® Corporation, or one or more virtual processors, as well as any combination of CPUs and virtual processors. Computing platform 1900 exchanges data representing inputs and outputs via input-and-output devices 1901, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 1900 performs specific operations by processor 1904 executing one or more sequences of one or more instructions stored in system memory 1906, and computing platform 1900 can be implemented in a client-server arrangement, peer-to-peer arrangement, or as any mobile computing device, including smart phones and the like. Such instructions or data may be read into system memory 1906 from another computer readable medium, such as storage device 1908. In some examples, hard-wired circuitry may be used in place of or in combination with software instructions for implementation. Instructions may be embedded in software or firmware. The term “computer readable medium” refers to any tangible medium that participates in providing instructions to processor 1904 for execution. Such a medium may take many forms, including but not limited to, non-volatile media and volatile media. Non-volatile media includes, for example, optical or magnetic disks and the like. Volatile media includes dynamic memory, such as system memory 1906.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1902 for transmitting a computer data signal.

In some examples, execution of the sequences of instructions may be performed by computing platform 1900. According to some examples, computing platform 1900 can be coupled by communication link 1921 (e.g., a wired network, such as LAN, PSTN, or any wireless network) to any other processor to perform the sequence of instructions in coordination with (or asynchronous to) one another. Computing platform 1900 may transmit and receive messages, data, and instructions, including program code (e.g., application code) through communication link 1921 and communication interface 1913. Received program code may be executed by processor 1904 as it is received, and/or stored in memory 1906 or other non-volatile storage for later execution.

In the example shown, system memory 1906 can include various modules that include executable instructions to implement functionalities described herein. In the example shown, system memory 1906 (e.g., in a mobile computing device, or a wearable computing device) can include a device controller module 1960 that includes an authenticator module 1962, a voice communication controller module 1964, a textual communication controller module 1966, and data archiver estimator module 1968.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

1. A method comprising:
receiving into an electronic device data representing a key configured to provide a lendee mode of access to one or more portions of the electronic device, the electronic device including identity control data specifying an entity having a lender mode of access to the electronic device;
authenticating the key to provide the lendee mode of access to the one or more portions of the electronic device;
determining a portion of the electronic device to which lendee access is permitted;
importing operation data into a memory to form imported operation data configured to facilitate a function of the portion of the electronic device;
receiving data representing a user input configured to initiate the function of the portion of the electronic device; and
causing the electronic device to perform the function based on the imported operation data in the lendee mode of access.

2. The method of claim 1, wherein the key facilitates automatic adoption of the electronic device for use by a first entity in the lendee mode of operation independent of the identity control data limiting the lender mode of access to a second entity.

3. The method of claim 1, further comprising:
detecting a wearable device from which the data representing the key originates.

4. The method of claim 3, wherein detecting the wearable device further comprises:
determining proximity of the wearable device relative to the electronic device; and
enabling authentication of the key if the wearable device is within a range of distances from the electronic device.

5. The method of claim 4, wherein determining proximity of the wearable device further comprising:
implementing near field communication (“NFC”) to establish a short-range communication link over which to convey the key.

6. The method of claim 3, further comprising:
determining a first entity that is wearing the wearable device for which the lendee mode of access is not authorized; and
disabling implementation access to the electronic device.

7. The method of claim 1, wherein causing the electronic device to perform the function comprises:
invoking a device controller configured to establish a communication link to communicate data packets as an electronic message; and
transmitting the data packets to a destination device based on contact data from the imported operation data.

8. The method of claim 7, wherein invoking the device controller further comprises:
invoking a voice communication controller configured to establish a voice-based data connection as the communication link,
wherein the operation data includes contact information including a plurality of names associated with a plurality of phone numbers.

9. The method of claim 7, wherein invoking the device controller further comprises:
invoking a textual communication controller configured to establish a text-based data connection as the communication link,
wherein the operation data includes email address information including a plurality of names associated with a plurality of email addresses.

10. The method of claim 1, wherein importing the operation data comprises:
retrieving the operation data from a wearable device from which the key data originates.

11. The method of claim 1, wherein receiving the data representing the user input configured comprises:
accepting data signals originating from a touch-sensitive screen.

12. The method of claim 1, further comprising:
denying access to the imported operation data under the lender mode of access.

13. An electronic device comprising:
a transceiver configured to receive key data and/or operation data via a short-range communication link;
a memory including:
identity control data configured to provide a first degree of access to a set of operations in a lender mode of operation, and
permission data configured to provide a second degree of access to a subset of the operations in a lendee mode of operation;
an authenticator configured to facilitate importation of the operation data in the lendee mode of operation; and
a device controller configured to facilitate the subset of the operations in the lendee mode as a function of the operation data.

14. The electronic device of claim 13, wherein the device controller comprises:
a short range antenna; and
a short range transceiver configured to receive at least the key data in the lendee mode of operation when a wearable device configured to transmit the key data is within a proximity of the electronic device.

15. The electronic device of claim 13, wherein the device controller comprises:
a voice communication controller configured to facilitate telephonic communications as a function of contact data as a portion of the operation data; and
a textual communication controller configured to facilitate text-based communications as a function of email address data as another portion of the operation data.

16. The electronic device of claim 15, further comprising:
a data archiver configured to store data representing amounts of data communicated in the lendee mode of operation, the amounts of data including either a first amount of data for the telephonic communications or a second amount of data for the text-based communications, or both.

17. A wearable device comprising:
a transceiver configured to transmit data via a short-range communication link;
a memory including:
key data specifying one or more conditions in which a wearer of the wearable device has lendee access to operations of an electronic devices, and
operation data specifying one or more portions of data to facilitate at least a subset of the operations of the electronic devices; and
an adoption controller configured to detect the short-range communication link, and further configured to transmit the key data and/or the operation data to the electronic device to transition the electronic device from a lender mode of operation to a lendee mode of operation to enable the wearer to use the electronic device.

18. The wearable device of claim 17, wherein the key data facilitates automatic adoption of the electronic device for use by the wearer in the lendee mode of operation independent of the lender mode of access associated with a lender of the electronic device.

19. The wearable device of claim 17, wherein the memory further comprises:
authenticated data specifying the wearer of the wearable device is authorized to use wearable device to cause adoption in the use of the electronic device.

20. The wearable device of claim 17, wherein the memory further comprises one or more of:
contact data configured to facilitate telephonic communications;
email address data configured to facilitate text-based communications; and
playlist data configured to facilitate playback of audio by the electronic device.
